(19) United States
(12) Patent Application Publication
(10) Pub. No.: US 2026/0246901 A1
(43) Pub. Date: Aug. 20, 2026

(54) HARDWARE-FOVEATED VIDEO SEE-THROUGH HEAD-MOUNTED DISPLAY

(71) Applicant: Snap Inc., Santa Monica, CA (US)

(72) Inventors: Christoph Ebner, Graz (AT); Denis Kalkofen, Graz (AT); Alexander Plopski, Graz (AT)

(21) Appl. No.: 19/223,619

(22) Filed: May 30, 2025

Related U.S. Application Data
(60) Provisional application No. 63/759,466, filed on Feb. 17, 2025.

(51) Int. Cl. H04N 13/111; H04N 13/296; H04N 13/366; H04N 13/398

(52) U.S. Cl. CPC H04N 13/111; H04N 13/296; H04N 13/366; H04N 13/398

(57) ABSTRACT

Systems and methods described herein relate to a video see-through (VST) head-mounted display (HMD) and to methods for operating such an HMD. In some examples, the HMD has a foveal capture system and a peripheral capture system. The foveal capture system captures high-resolution images in a direction corresponding to a viewing direction of a user and with a narrow field of view. The peripheral capture system captures additional images with a wider field of view and lower angular resolution. The HMD includes one or more processors that dynamically adjust the foveal capture system based on the viewing direction to enable the HMD to capture high-resolution images for providing a foveal view. The HMD may render processed images by combining foveal and peripheral captures. In some examples, this enables recording the real world with resolution similar to that of the human eye while maintaining feasible bandwidth requirements.

### CLAIM OF PRIORITY

This application claims the benefit of priority to U.S. Provisional Application Ser. No. 63/759,466, filed on Feb. 17, 2025, which is incorporated herein by reference in its entirety.

### TECHNICAL FIELD

Subject matter disclosed herein relates, generally, to extended reality (XR) technology. More specifically, but not exclusively, the subject matter relates to video see-through (VST) head-mounted displays (HMDs).

### BACKGROUND

The field of XR continues to grow. HMDs, including VST HMDs which is one category of XR device, have become increasingly popular. A VST HMD is a wearable device that captures the real-world environment and displays it to the user through one or more display components, rather than having the user view the world directly through, for example, optical elements. The VST HMD can present virtual content (e.g., digital effects) together with the real-world environment. VST HMDs thus mediate the user's view of the real world by capturing and processing one or multiple camera feeds before presenting them to the user's eyes.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 is a block diagram illustrating a network environment for operating an XR device, according to some examples.

FIG. 2 is a block diagram illustrating components of an XR device, according to some examples.

FIG. 3 is a diagrammatic representation of angular measurements related to visual field parameters, according to some examples.

FIG. 4 is a diagrammatic representation of regions in a processed image, according to some examples.

FIG. 5 is a front view of a body of a VST HMD, including a foveal capture system and a peripheral capture system, according to some examples.

FIG. 6 is a front perspective view of the body of the VST HMD of FIG. 5, according to some examples.

FIG. 7 is a side perspective view of the body of the VST HMD of FIG. 5, according to some examples.

FIG. 8 is an opposite side perspective view of the body of the VST HMD of FIG. 5, according to some examples.

FIG. 9 is a side view of the body of the VST HMD of FIG. 5, according to some examples.

FIG. 10 is an opposite view of the body of the VST HMD of FIG. 5, according to some examples.

FIG. 11 is a front view of a VST HMD, according to some examples, worn by a user.

FIG. 12 is a front perspective view of the VST HMD of FIG. 11, according to some examples, also shown as being worn by the user.

FIG. 13 is a flowchart illustrating a method for capture and display by an XR device, according to some examples.

FIG. 14 is a diagrammatic representation showing adjustment of foveal and peripheral regions in response to changes in viewing direction, according to some examples.

FIG. 15 illustrates a steerable mirror arrangement for a VST HMD, according to some examples.

FIG. 16 illustrates a network environment in which a head-wearable apparatus can be implemented, according to some examples.

FIG. 17 is a block diagram showing a software architecture within which the present disclosure may be implemented, according to some examples.

FIG. 18 is a diagrammatic representation of a machine in the form of a computer system within which a set of instructions may be executed for causing the machine to perform any one or more of the methodologies discussed herein, according to some examples.

### DETAILED DESCRIPTION

VST HMDs face technical challenges in capturing and displaying real-world environments to users in real-time. Specifically, achieving sufficient pixel density while maintaining reasonable data bandwidth requirements presents significant technical hurdles. Additionally, combining and aligning multiple camera views to create a cohesive display introduces complexities in image processing and display rendering. Due to technological limitations, VST systems typically have to balance tradeoffs between aspects such as field of view, resolution, latency, and computational requirements.

Traditional VST HMDs employ different approaches to capture the real-world environment. These approaches include the “cameras at eyes,” or CAE, approach, and the “cameras at periphery,” or CAP approach. The CAE approach involves placing two cameras approximately where the user's eyes are located to capture the entire field of view from approximately the perspective of the user's eyes. However, significant processing bandwidth is needed to capture the entire field of view at a sufficiently high resolution (e.g., over 180 or over 190 Gbits/s of data can be needed). This may cause excessive latency or even be infeasible for various XR devices since they typically have limited processing resources. The CAP approach involves arranging multiple peripheral cameras around the HMD to capture different portions of the field of view. However, this leads to visual distortions (e.g., due to the need to warp and combine the camera views) and poor quality.

Foveated vision refers to the way humans see, with high detail in the center of their gaze, while peripheral vision is less detailed. Examples in the present disclosure provide hardware-driven foveated displays in an XR context. At least some examples address the aforementioned challenges by providing foveated cameras aligned with a user's gaze to capture high-resolution detail only where needed, with added peripheral cameras for full visual context. By exploiting natural features of human perception, examples in the present disclosure reduce bandwidth requirements while maintaining visual quality. In some examples, the XR device dynamically adjusts its foveal cameras based on eye tracking to keep them aligned with where the user is looking.

Traditional VST HMD approaches face significant technical limitations that impact their practical implementation. The CAE approach, while providing natural perspective by placing cameras at eye positions, requires excessive bandwidth exceeding, for example, 190 Gbits/s to capture the entire field of view at sufficient resolution to match human visual acuity. This makes real-time processing infeasible on mobile computing devices with limited resources. The CAP approach can reduce bandwidth by using multiple peripheral cameras, but can introduce substantial visual distortions from warping and combining different camera views, resulting in poor image quality.

In contrast, the hardware-foveated approach described herein can help to achieve both natural perspective and efficient bandwidth usage by capturing high-resolution detail only where needed-in the user's viewing direction. For example, when using a foveal capture system operating at 1088×1088 pixels over a 12-degree field of view combined with peripheral capture at 1456×1088 pixels covering 100 degrees by 70 degrees, the total bandwidth requirement may be approximately 28 Gbits/s. This represents an approximately 85% reduction in bandwidth compared to at least some traditional CAE implementations while maintaining high visual quality in the user's foveal region where acuity matters most. Additionally, by positioning foveal cameras at eye level, this approach minimizes distortion in the high-resolution central view while limiting any warping artifacts to peripheral regions where human visual acuity is naturally lower.

In some examples, a VST HMD employs two types of camera systems: a foveal capture system with a narrow field of view (e.g., less than 25 degrees) and high resolution (e.g., at least 60 pixels per degree), and a peripheral capture system with wider field of view and lower resolution. The foveal cameras dynamically align with the user's gaze direction. This selective high-resolution capture can match a human visual system's natural characteristics, where peak acuity occurs in a relatively small central region. Each capture system can include one or multiple optical sensors (e.g., cameras).

The VST HMD may process and combine camera feeds to create a more seamless view. High-resolution foveal imagery provides clear detail where the user is looking, while lower-resolution peripheral capture supplies environmental context. In some examples, the VST HMD includes one or more eye tracking sensors to determine viewing direction, depth sensors for focus adjustment, and processing components to handle image capture, warping, stitching, and blending. Some implementations may use steerable mirrors instead of moving cameras, offering fast response times and reliability. The VST HMD can also incorporate varifocal capabilities to adjust focus depth based on gaze point and depth information.

Processed images may comprise a foveal region displaying the high-resolution foveal view, surrounded by a peripheral region displaying the wider-angle peripheral view. A blending function, which may be linear in some implementations, can be applied between these regions. A stitching function can be applied to combine images. The processed image may include a transition region between the foveal and peripheral regions where images from both capture systems are blended. Within this transition region, a processor may perform opacity adjustment and color correction. The peripheral views may be warped towards the foveal views before views are stitched and blending is applied.

Dynamic adjustment of the foveal capture system may be achieved through physical movement of image sensors relative to the HMD frame or by manipulating optical paths using, for instance, steerable mirrors. The HMD may include specific steering mechanisms or steerable mirrors for this purpose. In some examples, the peripheral capture system comprises at least two peripheral image sensors to capture different portions of the peripheral field of view, with the processors combining these different portions to generate a peripheral view that is combined with the foveal view.

In some examples, the foveal capture system achieves angular resolutions of at least 70, 80, or 90 pixels per degree (e.g., in horizontal field of view). The field of view of the foveal capture system may be less than 20 degrees in some implementations, or less than 15 degrees in other implementations (e.g., in horizontal field of view). The foveal capture system may comprise two or more image sensors positioned approximately at eye level of the user to capture images from a perspective corresponding to the user's eyes.

The peripheral capture system may include multiple image sensors spaced apart laterally around a body or frame of the HMD. In some examples, the peripheral capture system includes at least two peripheral image sensors configured to capture different portions of a peripheral field of view, while other implementations may use at least four peripheral image sensors.

However, other configurations are also possible. For instance, in one example, the foveal capture system includes two cameras positioned approximately at the user's eye positions, while the peripheral capture system includes a single camera located between the two foveal cameras. One or more processors may perform object tracking using the additional images from the peripheral capture system.

The foveal capture system may include one or more varifocal mechanisms to adjust focus depth of the images. The one or more processors may determine the focus depth using at least one of: a depth camera, gaze point data, or eye analysis data. In some implementations, the peripheral capture system comprises fixed-focus cameras while the foveal capture system uses varifocal cameras.

In some examples, a display arrangement of the HMD includes elements that adjust the focus depth of displayed images based on focus depth information determined by the capture system. For example, the HMD processes the aforementioned data to determine appropriate focus depth, and a display controller adjusts optical elements to present content at a display image plane matching the determined focus depth.

In some examples, the foveal capture system comprises a single image sensor with an optical system to create multiple optical paths from different directions. The optical system may include switching means such as a digital micromirror device (DMD) to rapidly switch the optical paths between different directions. When using this configuration, the single image sensor may operate at a frame rate of at least 180 Hz, or at least 200 Hz, with the processors temporally multiplexing the optical paths. The peripheral capture system may operate at a first frame rate while the foveal capture system operates at a second, lower frame rate.

The present disclosure includes devices, systems, and methods. An example method is performed by a VST HMD and includes capturing first images in a direction corresponding to a viewing direction of a user using a first field of view of less than 25 degrees at a first angular resolution of at least 60 pixels per degree. The example method further includes capturing second images using a second field of view and at a second angular resolution, where the second field of view is wider than the first field of view and the second angular resolution is lower than the first angular resolution. The example method further includes dynamically adjusting the capturing of the first images based on changes in the viewing direction and rendering processed images based on combining the first images and second images.

In some examples, an XR device (e.g., the VST HMD) provides augmented reality (AR) functionality. AR may include an interactive experience of a real-world environment where physical objects or environments that reside in the real world are “augmented” or enhanced by computer-generated digital content (also referred to as virtual content). AR may include a system that enables a combination of real and virtual worlds, real-time interaction, and three-dimensional (3D) presentation of virtual and real objects. A user of an AR system may perceive virtual content that appears to be attached or interact with a real-world physical object. In some examples, AR overlays digital content on the real world. Alternatively, or additionally, AR combines real-world and digital elements. The term “AR” may thus include mixed reality experiences. The term “XR application” is used herein to refer to a computer-operated application that enables an XR experience, such as an AR experience that presents virtual content together with real-world features captured by the XR device.

As mentioned, VST HMDs face a technical challenge in managing data bandwidth requirements when capturing high-resolution imagery. Traditional approaches require significant bandwidth to achieve sufficient pixel density matching human visual acuity, which can exceed the capabilities of mobile computing devices. The subject matter described herein addresses this limitation through a foveal capture system that captures high-resolution images only in the user's viewing direction with a narrow field of view, while using a peripheral capture system with wider field of view at lower resolution. This can provide significant savings in bandwidth requirements. For example, and as mentioned elsewhere in the present disclosure, when using a foveal capture system that captures 1088×1088 pixels images over a 12-degree field of view together with a peripheral capture system capturing at 1456×1088 pixels and covering a 100-degree by 70-degree field of view, bandwidth requirements can be reduced to approximately 28 Gbits/s compared to a traditional CAE implementation that may consume over 190 Gbits/s to provide approximately the same level of detail in the user's view.

Examples in the present disclosure can also address warping artifacts and loss of detail. For example, the technical solution involves positioning foveal cameras approximately at eye level to capture relatively undistorted high-resolution images in the viewing direction, while limiting warping artifacts to peripheral regions where human visual acuity is naturally lower. The system applies blending functions between regions and performs color correction in transition zones to create seamless integration.

Furthermore, real-time processing of multiple video streams while maintaining low latency presents substantial computational challenges within the constraints of a mobile device. The subject matter in the present disclosure addresses these constraints through a multi-component technical architecture where an eye tracking system continuously monitors viewing direction to trigger dynamic adjustments of the foveal capture system. In some examples, the system processes foveal and peripheral captures in parallel streams, with peripheral cameras potentially operating at higher frame rates for tracking while foveal cameras focus on detail capture. This architecture can help the system to maintain a suitable refresh rate (e.g., 90 Hz) while managing computational requirements through selective high-resolution processing.

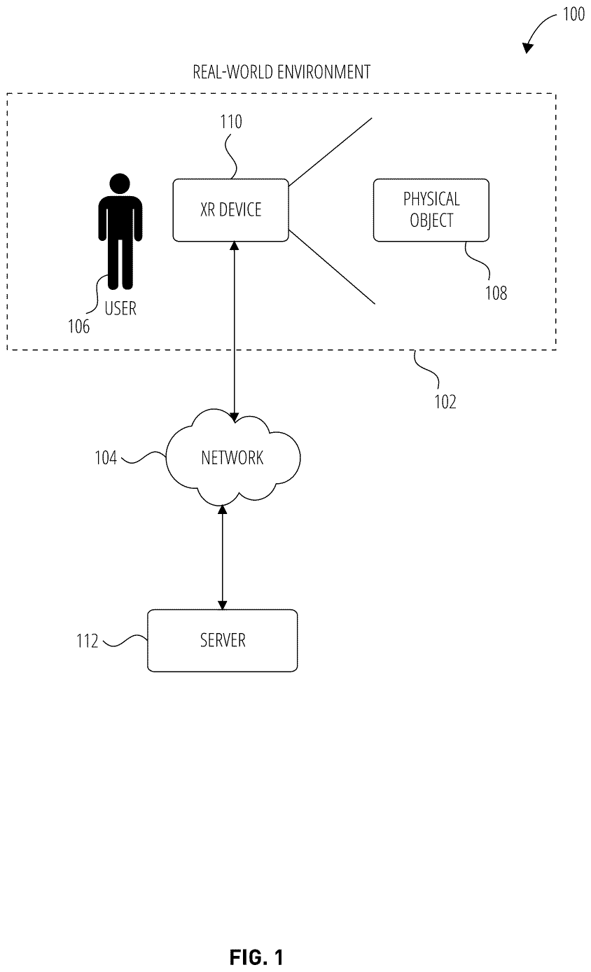

FIG. 1 is a network diagram illustrating a network environment 100 suitable for operating an XR device 110, according to some examples. The network environment 100 includes an XR device 110 and a server 112, communicatively coupled to each other via a network 104. The server 112 may be part of a network-based system. For example, the network-based system can be or include a cloud-based server system that provides additional information, such as virtual content (e.g., 3D models of virtual objects, or augmentations to be applied as virtual overlays onto images depicting real-world scenes) to the XR device 110.

A user 106 operates the XR device 110. The user 106 may be a human user (e.g., a human being), a machine user (e.g., a computer configured by a software program to interact with the XR device 110), or any suitable combination thereof (e.g., a human assisted by a machine or a machine supervised by a human).

The user 106 is not part of the network environment 100, but is associated with the XR device 110. For example, where the XR device 110 is a head-wearable apparatus, the user 106 wears the XR device 110 during a user session.

The XR device 110 may have different display arrangements. In some examples, the display arrangement may include a screen or projector that displays virtual content and/or what is captured with a camera of the XR device 110. The display may be positioned in the gaze path of the user or offset from the gaze path of the user.

Examples of XR devices that can provide AR features include optical see-through (OST) displays and VST displays, also known as video pass-through (VPT) displays. In OST technologies, a user views the physical environment directly through transparent or semi-transparent display components, and virtual content can be rendered to appear as part of, or overlaid upon, the physical environment. In VST/VPT technologies, a view of the physical environment is captured by one or more cameras and then presented to the user on an opaque display (e.g., in combination with virtual content). Examples in the present disclosure relate to VST/VPT technologies.

In some examples, the user 106 operates an application of the XR device 110. An XR application may be configured to provide the user 106 with an experience triggered or enhanced by a physical object 108, such as a two-dimensional (2D) physical object (e.g., a picture), a 3D physical object (e.g., a statue), a location (e.g., at factory), or references (e.g., perceived corners of walls or furniture, or digital codes) in a real-world environment 102. For example, the user 106 can point a camera of the XR device 110 to capture an image of the physical object 108 and a virtual overlay may be presented over the physical object 108 via the display.

Experiences may also be triggered or enhanced by a hand or other body part of the user 106. For example, the XR device 110 may detect and respond to hand gestures or signals. When using some XR devices, such as head-wearable devices, the hand of the user serves as an interaction tool. As a result, the hand is often “visible” to the XR device 110, with virtual content being rendered to appear on or close to the hand.

The XR device 110 includes tracking components (not shown in FIG. 1). The tracking components track the pose (e.g., position and orientation) of the XR device 110 relative to the real-world environment 102 using image sensors (e.g., depth-enabled 3D camera and image camera), inertial sensors (e.g., gyroscope, accelerometer, or the like), wireless sensors (e.g., Bluetooth™ or Wi-Fi™), a Global Positioning System (GPS) sensor, and/or audio sensor to determine the location of the XR device 110 within the real-world environment 102. In some examples, the tracking components track the pose of the hand (or hands) of the user 106 or some other physical object 108 in the real-world environment 102.

In some examples, the server 112 is used to detect and identify the physical object 108 based on sensor data (e.g., image and depth data) from the XR device 110, and determine a pose of the XR device 110, the physical object 108 and/or the hand of the user 106 based on the sensor data. The server 112 can also generate virtual content based on the pose of the XR device 110, the physical object 108, and/or the hand.

In some examples, the server 112 communicates virtual content (e.g., a virtual object) to the XR device 110. The XR device 110 or the server 112, or both, can perform image processing, object detection, and object tracking functions based on images captured by the XR device 110 and one or more parameters internal or external to the XR device 110.

The object recognition, tracking, and content rendering can be performed on either the XR device 110, the server 112, or a combination between the XR device 110 and the server 112. Accordingly, while certain functions are described herein as being performed by either an XR device or a server, the location of certain functionality may be a design choice (unless specifically indicated to the contrary). For example, it might be technically preferable to deploy particular technology and functionality within a server system initially, but later to migrate this technology and functionality to a client installed locally at the XR device where the XR device has sufficient processing capacity.

The network 104 may be any network that enables communication between or among machines (e.g., server 112), databases, or devices (e.g., XR device 110). Accordingly, the network 104 may be a wired network, a wireless network (e.g., a mobile or cellular network), or any suitable combination thereof. The network 104 may include one or more portions that constitute a private network, a public network (e.g., the Internet), or any suitable combination thereof.

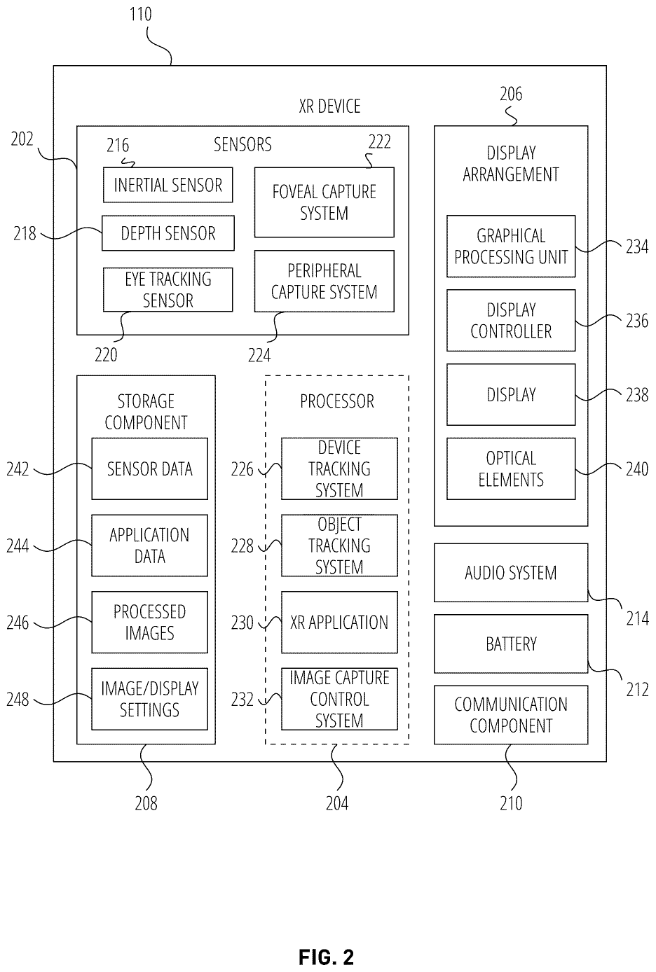

FIG. 2 is a block diagram illustrating components (e.g., modules, parts, or systems) of the XR device 110 of FIG. 1, according to some examples. The XR device 110 is shown in FIG. 2 to include sensors 202, a processor 204, a display arrangement 206, a storage component 208, and a communication component 210. The XR device 110 is further shown to include a battery 212 and an audio system 214. It will be appreciated that FIG. 2 is not intended to provide an exhaustive indication of components of the XR device 110.

The sensors 202 include one or more inertial sensors 216, one or more depth sensors 218, and one or more eye tracking sensors 220. In some examples, the inertial sensor 216 includes a combination of a gyroscope, accelerometer, and a magnetometer. In some examples, the inertial sensor 216 includes one or more Inertial Measurement Units (IMUs). An IMU enables tracking of movement of a body by integrating the acceleration and the angular velocity measured by the IMU. An IMU can include a combination of accelerometers and gyroscopes that can determine and quantify linear acceleration and angular velocity, respectively. The values obtained can be processed to obtain the pitch, roll, and heading of the IMU and, therefore, of the body with which the IMU is associated. Signals from the accelerometers of the IMU also can be processed to obtain velocity and displacement. The IMU may also include one or more magnetometers.

The depth sensor 218 may include one or a combination of a structured-light sensor, a time-of-flight sensor, passive stereo sensor, or an ultrasound device. The eye tracking sensor 220 is configured to monitor the gaze direction of the user, providing data for various applications, such as determining where to render virtual content of an XR application 230. The XR device 110 may include one or multiple of these sensors, such as infrared eye tracking sensors, corneal reflection tracking sensors, or video-based eye-tracking sensors. In some examples, the eye tracking sensor 220 is part of an eye tracking system that is used to adjust a foveal capture system 222 as described below.

In addition, the sensors 202 include various image sensors. For example, the sensors 202 can include one or multiple of each of: a color camera, a thermal camera, a grayscale, global shutter tracking camera.

In FIG. 2, the sensors 202 include the foveal capture system 222 and the peripheral capture system 224. Each of the foveal capture system 222 and a peripheral capture system 224 include at least one color camera.

In some examples, the foveal capture system 222 includes cameras configured to capture high-resolution images in a direction corresponding to the user's viewing direction, with a field of view of less than 25 degrees and an angular resolution of at least 60 pixels per degree. In some examples, the foveal capture system includes varifocal mechanisms to adjust focus depth based on eye tracking and depth sensor data.

In some examples, the foveal capture system includes mechanical components to physically move the cameras relative to the frame of the XR device 110. The system may include a steering mechanism comprising precision motors and actuators that enable camera movement within a range (e.g., a 25 degree range) before head movement becomes necessary. The mechanical system responds to eye tracking data to dynamically adjust and align the foveal cameras with the user's gaze direction, maintaining high-resolution capture where the user is looking.

Alternatively, the foveal capture system may employ optical components to manipulate incoming light paths without physical camera movement. This implementation can use steerable mirrors to rapidly redirect optical paths to different viewing directions. In some examples, the system includes a DMD to enable temporal multiplexing of optical paths from different directions to a single high-speed camera.

In some examples, the peripheral capture system 224 includes multiple cameras spaced around the XR device 110 to capture a wider field of view at lower resolution compared to the foveal capture system. The peripheral cameras may be fixed-focus cameras operating at a higher frame rate than the foveal cameras to enable object tracking and environmental awareness.

Other examples of sensors 202 include a proximity or location sensor (e.g., near field communication, GPS, Bluetooth™, or Wi-Fi™), an audio sensor (e.g., a microphone), or any suitable combination thereof. It is noted that the sensors 202 described herein are for illustrative purposes and the sensors 202 are thus not limited to the ones described above.

The processor 204 executes or facilitates implementation of a device tracking system 226, an object tracking system 228, the XR application 230, and an image capture control system 232.

The device tracking system 226 estimates a pose of the XR device 110. For example, the device tracking system 226 uses data from cameras and inertial sensors to track a location and pose of the XR device 110 relative to a frame of reference (e.g., real-world environment 102). In some examples, the device tracking system 226 uses sensor data from the sensors 202 to determine the pose of the XR device 110. The pose may be a determined orientation and position of the XR device 110 in relation to the user's real-world environment 102.

In some examples, the device tracking system 226 continually gathers and uses updated sensor data describing movements of the XR device 110 to determine updated poses of the XR device 110 that indicate changes in the relative position and orientation of the XR device 110 from the physical objects in the real-world environment 102. In some examples, the device tracking system 226 provides the pose of the XR device 110 to a graphical processing unit 234 of the display arrangement 206.

The object tracking system 228 enables the tracking of an object, such as the physical object 108 of FIG. 1, or a hand of a user. The object tracking system 228 may include a computer-operated application or system that enables a device or system to track visual features identified in images captured by one or more image sensors. In some examples, the object tracking system builds a model of a real-world environment based on the tracked visual features. An object tracking system may implement one or more object tracking machine learning models to track an object in the field of view of a user during a user session. The object tracking machine learning model may comprise a neural network trained on suitable training data to identify and track objects in a sequence of frames captured by the XR device 110. The object tracking machine learning model may use an object's appearance, motion, landmarks, and/or other features to estimate location in subsequent frames.

In some examples, the device tracking system 226 and/or the object tracking system 228 implements a “SLAM” (Simultaneous Localization and Mapping) system to understand and map a physical environment in real-time. This allows, for example, the XR device 110 to accurately place digital objects in the real world and track their position as a user moves and/or as objects move. The XR device 110 may include a “VIO” (Visual-Inertial Odometry) system that combines data from an IMU and a camera to estimate the position and orientation of an object in real-time.

The XR application 230 may retrieve virtual content, such as a virtual object (e.g., 3D object model) or other augmentation, based on an identified physical object 108, physical environment (or other real-world feature), or user input (e.g., a detected gesture). The graphical processing unit 234 of the display arrangement 206 causes display of the virtual object, augmentation, or the like.

In some examples, the XR application 230 includes a local rendering engine that generates a visualization of a virtual object overlaid (e.g., superimposed upon, mixed with, or otherwise displayed in tandem with) on an image of the physical object 108 (or other real-world feature) captured by an image sensor. A visualization of the virtual object may be manipulated by adjusting a position of the physical object or feature (e.g., its physical location, orientation, or both) relative to the image sensor/s. Similarly, the visualization of the virtual object may be manipulated by adjusting a pose of the XR device 110 relative to the physical object or feature.

The image capture control system 232 manages the dynamic adjustment of the foveal capture system 222 based on the user's viewing direction. In some examples, the image capture control system 232 processes eye tracking data to determine gaze direction changes and coordinates either physical camera movement or optical path steering via mirrors. For example, the eye tracking sensor 220 tracks the user gaze and provides 3D gaze data, such as a point or points in 3D space relative to a coordinate system of the XR device 110 to the image capture control system 232. The image capture control system 232 filters the gaze data and controls the foveal capture system 222 to adjust (e.g., rotate) such that it is directed at the relevant point or points in 3D space as returned via the filter.

The image capture control system 232 may also control frame rate differences between foveal and peripheral captures, with peripheral cameras potentially operating at higher rates. Individual frame rates may depend on factors such as the bandwidth the XR device 110 can provide. As an example, the foveal capture system 222 can operate at 90 Hz while the frame rate of the peripheral capture system 224 is reduced to 75 Hz to lower bandwidth.

In some examples, an eye tracking system measures viewing direction through both azimuth (horizontal) and altitude (vertical) angles to determine the user's gaze direction. In some examples, the eye tracking system accounts for the physical offset between the eye position and camera position when calculating how to adjust the foveal capture system 222. This offset compensation can help the foveal cameras or optical paths to be properly aligned to capture high-resolution images from the correct perspective.

For implementations using a single camera with DMD, the system manages temporal multiplexing of optical paths. In some examples, the foveal capture system 222 may thus use a DMD to rapidly switch between capturing views for different eyes. The DMD operates by alternating between two states—position 1 to capture the right eye view and position 0 to capture the left eye view. This allows a single high-speed camera operating at over 200 Hz to capture separate views for each eye through temporal multiplexing of the optical paths. The DMD functions as a high-speed controllable mirror that can rapidly redirect the optical path between the two eye positions. The switching occurs faster than the critical flicker fusion threshold of human vision, preventing the user from perceiving any flickering in the displayed image. The system processes these temporally multiplexed captures to generate seamless views for both eyes while maintaining the high angular resolution of at least 60 pixels per degree in the foveal region. This approach can facilitate efficient foveal capture for both eyes using a single camera rather than requiring separate cameras for each eye.

In some examples, the graphical processing unit 234 (e.g., together with the XR application 230) performs several functions related to combining and processing images from the foveal capture system 222 and the peripheral capture system 224. For example, the graphical processing unit 234 receives high-resolution foveal images captured at, for example, 80 or 90 pixels per degree within a narrow field of view by the foveal capture system 222, along with wider-angle lower resolution peripheral images captured by the peripheral capture system 224. The graphical processing unit 234 then warps the peripheral views to align with the foveal views before applying blending functions between the regions.

In some examples, the graphical processing unit 234 operates on separate camera feeds to stitch views together to generate a complete view. For example, different peripheral views are stitched together before they can be blended with the foveal view. In some examples, the graphical processing unit 234 warps and stitches the peripheral views together, then applies blending functions between this composite peripheral view and the high-resolution foveal capture to create seamless transitions. This two-step process of first stitching the peripheral views and then combining and blending with the foveal region can provide proper alignment and integration of all camera feeds into a cohesive final image.

In some examples, the graphical processing unit 234 works with the XR application 230 or the image capture control system 232 to dynamically adjust image processing based on the user's viewing direction. The graphical processing unit 234 may apply linear or other blending functions in transition regions between foveal and peripheral views, perform color correction and opacity adjustments, and manage the different frame rates between the capture systems. Operations such as color correction and opacity adjustments are not necessarily limited to transition regions and can also be applied in other zones. This processing occurs in parallel with object tracking and pose estimation for proper alignment of virtual and real-world content.

The display arrangement 206 may further include a display controller 236, a display 238 (or multiple displays), and optical elements 240. The optical elements 240 may include one or more display components and one or more lenses, mirrors, waveguides, filters, diffusers, or prisms, which work together to present virtual content to the user. The design of the optical elements 240 can vary depending on the desired field of view, image clarity, and form factor of the XR device 110.

The display 238 may include a screen or panel configured to display images generated by the processor 204 or the graphical processing unit 234. The display 238 may include one or more components or devices to present images, videos, or graphics to a user. The display 238 may include electronic panels or screens. Technologies such as LCDs, organic light-emitting diodes (OLEDs), micro-LEDs, or projection-based systems may be incorporated into the display 238. In some examples, visual content is provided separately to each eye for a stereoscopic view.

In some examples, the display arrangement 206 provides an optical assembly using, for example, focusing lenses and other optical elements, to present virtual content at different image planes. These different image planes may correspond to different focus depths.

Referring again to the graphical processing unit 234, the graphical processing unit 234 may include a render engine that is configured to render a frame of a 3D model of a virtual object based on the virtual content provided by the XR application 230 and the pose of the XR device 110 (and, in some cases, the position of a tracked object). In other words, the graphical processing unit 234 uses the pose information as well as predetermined content data to generate frames of virtual content to be presented on the display 238. For example, the graphical processing unit 234 uses the pose to render a frame of the virtual content such that the virtual content is presented at an orientation and position in the display 238 to properly augment the user's reality.

As an example, the graphical processing unit 234 may use the pose data and other sensor data to render a frame of virtual content such that, when presented on the display 238, the virtual content is caused to be presented to a user so as to overlap with a physical object in the user's real-world environment 102. The graphical processing unit 234 can generate updated frames of virtual content based on currently captured images (e.g., as blended from the foveal capture system 222 and the peripheral capture system 224), updated poses of the XR device 110 and updated tracking data generated by the abovementioned tracking components, which reflect changes in the position and orientation of the user in relation to physical objects in the user's real-world environment 102, thereby resulting in a more immersive experience.

In some examples, the XR device 110 uses predetermined properties of a virtual object (e.g., an object model with certain dimensions, textures, transparency, and colors) along with lighting estimates and pose data to render virtual content within an XR environment in a way that is visually coherent with the real-world lighting conditions.

Referring again to the display arrangement 206, the graphical processing unit 234 transfers a rendered frame (e.g., a composite view from the foveal capture system 222 and the peripheral capture system 224 together with the virtual content to which the aforementioned processing has been applied) to the display controller 236. In some examples, the display controller 236 is positioned as an intermediary between the graphical processing unit 234 and the display 238, receives the image data (e.g., rendered frame) from the graphical processing unit 234, re-projects the frame (by performing a warping process) based on a latest pose of the XR device 110 (and, in some cases, object tracking pose forecasts or predictions), and provides the re-projected frame to the display 238.

It will be appreciated that, in examples where an XR device includes multiple displays, each display may have a dedicated graphical processing unit and/or display controller and/or optical assembly. It will further be appreciated that where an XR device includes multiple displays, e.g., in the case of an HMD or another AR device that provides binocular vision to mimic the way humans naturally perceive the world, a left eye display arrangement and a right eye display arrangement may deliver separate images or video streams to each eye. Where an XR device includes multiple displays, steps may be carried out separately and substantially in parallel for each display and/or optical assembly, in some examples, and pairs of features or components may be included to cater for both eyes.

For example, an XR device may capture separate images for a left eye display and a right eye display (or for a set of right eye displays and a set of left eye displays), and render separate outputs for each eye to create a more immersive experience and to adjust the focus and convergence of the overall view of a user for a more natural, 3D view. Thus, while a single set of display arrangement components may be discussed to describe some examples, similar techniques may be applied to cover both eyes by providing a further set of display arrangement components.

In some examples, audio system 214 enables audio input/output capabilities for the XR device 110. The battery 212 provides portable power to the various components of the XR device 110.

The storage component 208 may store various data, such as sensor data 242, application data 244, processed images 246, and image/display settings 248. In some examples, some of the data of the storage component 208 is stored at the XR device 110 while other data is stored at the server 112.

Sensor data 242 may include data obtained from one or more of the sensors 202, such as image frames captured by the cameras and IMU data including inertial measurements. The application data 244 may include content and instructions provided by the software applications running on the XR device 110, such as the XR application 230. Application data 244 may include application instructions and features, and specifications and/or characteristics of virtual content. This data may include user interface elements, 3D models, textures, animations, and interactive elements that the user will engage with in the virtual environment.

The processed images 246 may include images processed to combine views captured by the foveal capture system 222 with views captured by the peripheral capture system 224. The image/display settings 248 may include parameters and options used by the XR device 110 to process images, and render and display virtual content. The image/display settings 248 may determine visual quality, performance, or rendering techniques used to generate the virtual environment. Examples of rendering settings may include resolution, frame rate, shading models, visual fidelity, performance parameters, and lighting techniques. Accordingly, the image/display settings 248 may include configuration data stored within the storage component 208 that regulates how virtual content is rendered by the XR device 110 (e.g., via the graphical processing unit 234).

The image/display settings 248 may include configuration parameters for the foveal capture system 222 and/or the peripheral capture system 224. In some examples, these settings include field of view specifications, resolution settings, and frame rate configurations for both capture systems. The settings may also specify parameters for varifocal operation and focus depth adjustment of the foveal cameras.

The image/display settings 248 may include parameters for combining and processing the captured images from both systems. These settings specify, for example, blending functions between foveal and peripheral regions, stitching functions, color correction and opacity adjustment parameters for transition zones, and warping configurations for aligning peripheral views with foveal views.

The communication component 210 of the XR device 110 enables connectivity and data exchange. For example, the communication component 210 enables wireless connectivity and data exchange with external networks and servers, such as the server 112 of FIG. 1. This can allow certain functions described herein to be performed at the XR device 110 and/or at the server 112.

The communication component 210 may allow the XR device 110 to transmit and receive data, including software updates, machine learning models, and cloud-based processing tasks. In some examples, the communication component 210 facilitates the offloading of computationally intensive tasks to the server 112. Additionally, the communication component 210 can allow for synchronization or networking with other devices in a multi-user XR environment, enabling participants to have a consistent and collaborative experience (e.g., in a multi-player AR game or an AR presentation mode).

In some examples, at least some of the components shown in FIG. 2 are configured to communicate with each other to implement aspects described herein. One or more of the components described may be implemented using software, hardware (e.g., one or more processors of one or more machines), or a combination of hardware and software. For example, a component described herein may be implemented by a processor configured to perform the operations described herein for that component. Moreover, two or more of these components may be combined into a single component, or the functions described herein for a single component may be subdivided among multiple components. Furthermore, according to various examples, components described herein may be implemented using a single machine, database, or device, or be distributed across multiple machines, databases, or devices.

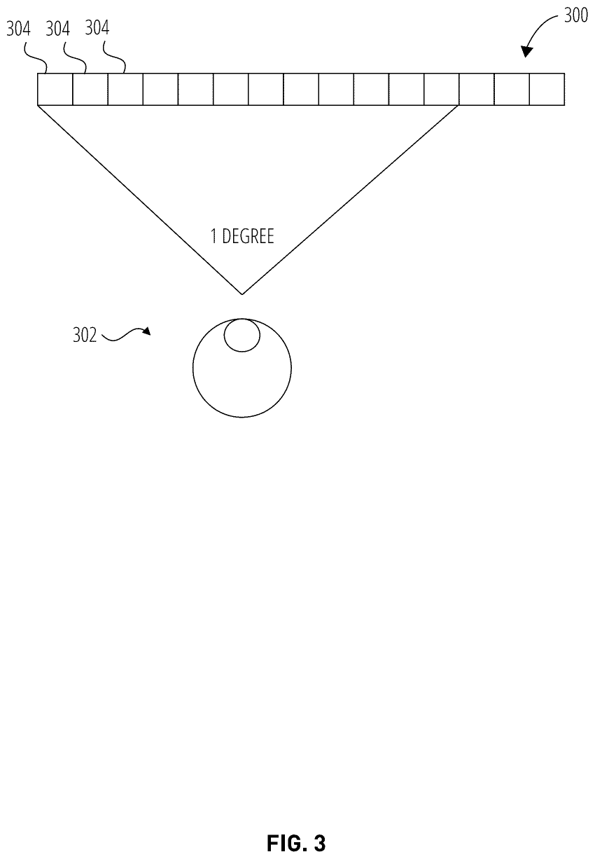

FIG. 3 diagrammatically illustrates a virtual image 300 provided via a display comprising pixels 304, and an eye 302 of a user. For example, the user wears the XR device 110 and views the real-world environment with virtual content overlaid thereon by way of the virtual image 300 presented by the XR device 110. It is noted that, in VST HMD implementations, the user typically views the display through an optical element such as a lens to see the virtual image 300. FIG. 3 shows a one-degree visual angle to demonstrate pixels per degree (ppd) measurements, according to some examples. In FIG. 3, twelve of the pixels 304 correspond to the one-degree visual angle, thus providing a 12 ppd view.

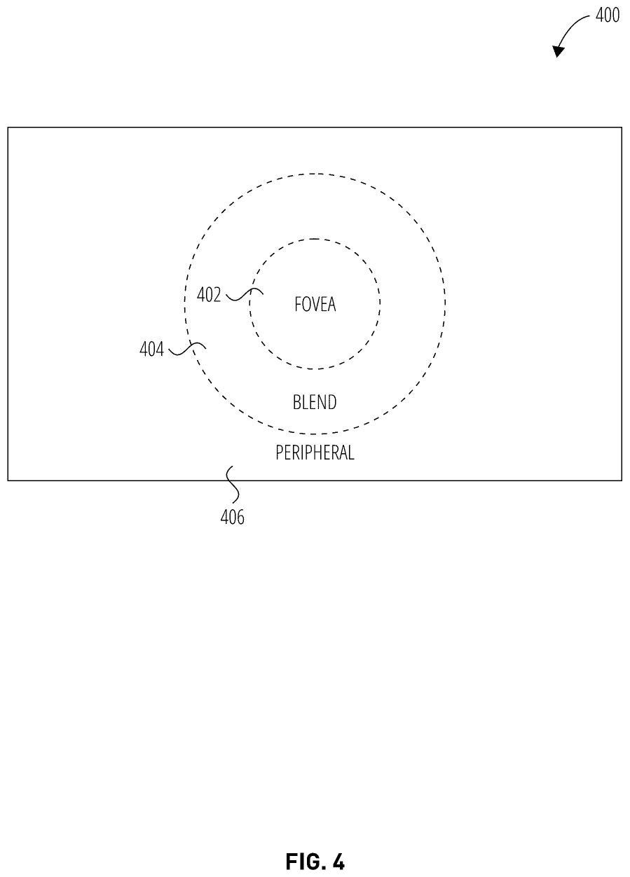

FIG. 4 shows a rendered view 400, according to some examples. The rendered view 400 includes a foveal region 402 (labeled “FOVEA”), a transition region 404 (labeled “BLEND”), and a peripheral region 406 (labeled “PERIPHERAL”). The rendered view 400 can be presented via a display, such as the display 238 of the XR device 110.

The rendered view 400 shown in FIG. 4 is generated through a multi-step process that combines high-resolution foveal capture with lower-resolution peripheral capture. The foveal region 402 corresponds to the user's current viewing direction and displays detail captured by the foveal capture system 222 at a higher angular resolution within a smaller field of view. The peripheral region 406 surrounds the foveal region 402 and displays wider-angle views captured by the peripheral capture system 224 at lower resolution.

Between these regions, the transition region 404 provides a smooth transition between the high-resolution foveal view and lower-resolution peripheral view. The XR device 110 can apply blending functions in the transition region 404 while performing color correction and opacity adjustments to integrate the different resolution zones.

In some examples, the system applies a “smoothstep” blending function to decrease the opacity of the foveal view towards the periphery within a single blend region. The blending function creates a smooth transition between the high-resolution foveal capture and lower-resolution peripheral capture by gradually adjusting opacity levels. The XR device 110 (e.g., the graphical processing unit 234) applies this blending function in the transition region while also performing color correction to help with integration between the different resolution zones. The transition region surrounds the foveal region and provides continuous blending into the peripheral region to match natural visual characteristics.

In some examples, the XR device 110 performs color correction through a two-stage process. The first stage involves offline color balancing calibration of the foveal and peripheral cameras to establish baseline color consistency. During runtime operation, the graphical processing unit applies a linear color mapping to address any remaining color inconsistencies between the camera feeds. This color correction occurs in the transition region along with opacity adjustments to create seamless blending between the high-resolution foveal capture and lower-resolution peripheral capture. The image processing settings specify the parameters for both the initial calibration and runtime color mapping to maintain consistent color reproduction across the full field of view.

The rendered view 400 leverages natural human vision characteristics, where visual acuity drops rapidly outside the central foveal area. The subject matter described herein implements foveated rendering through dedicated hardware capture systems rather than solely through software post-processing. For example, the foveal capture system 222 uses physically separate cameras positioned approximately at eye level to capture high-resolution images in the viewing direction, while peripheral cameras capture wider-angle views at lower resolution. This hardware-based approach can help the XR device 110 to capture different resolutions directly during image acquisition, rather than capturing uniform high-resolution images and then downsampling in software. A graphical processing unit can combine these regions by first warping the peripheral views towards the foveal views, then applying the blending functions to create a seamless composite image. Using accurate eye tracking and dynamic adjustments, the area of highest resolution can be matched to the fovea on the retina.

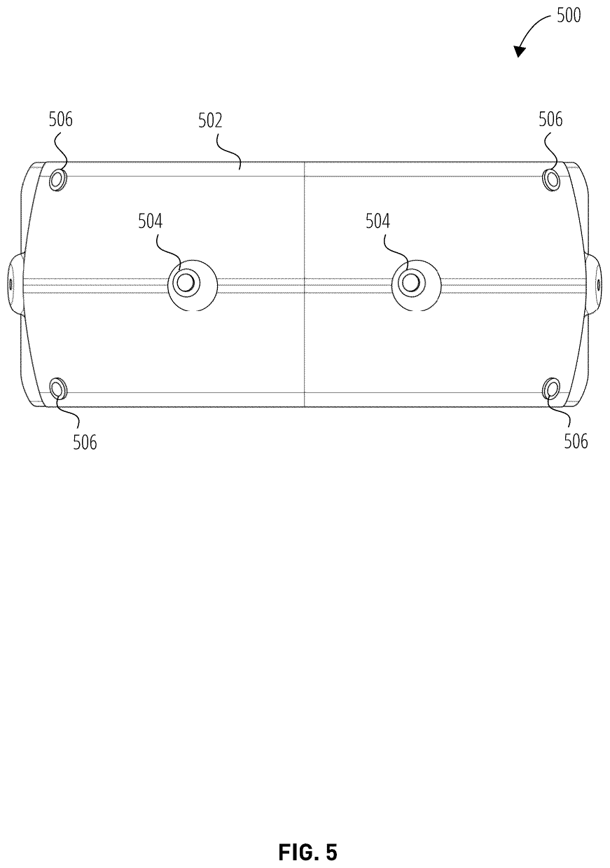

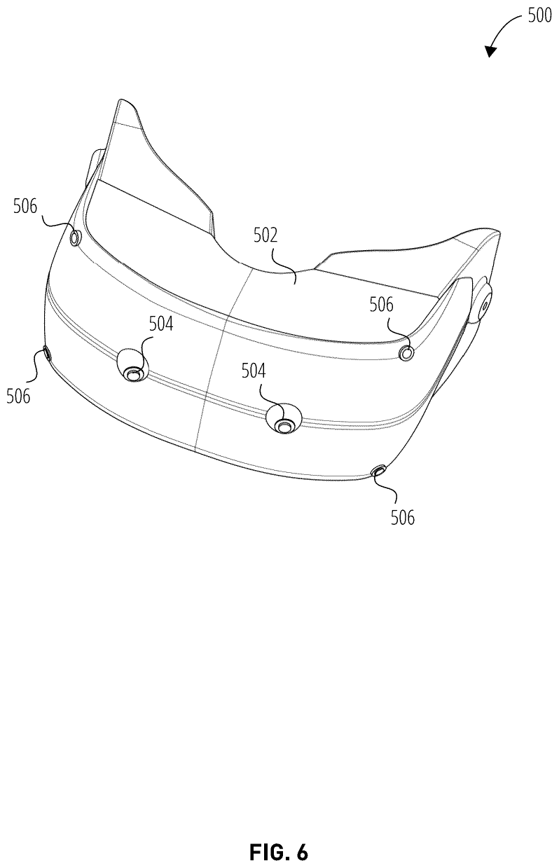

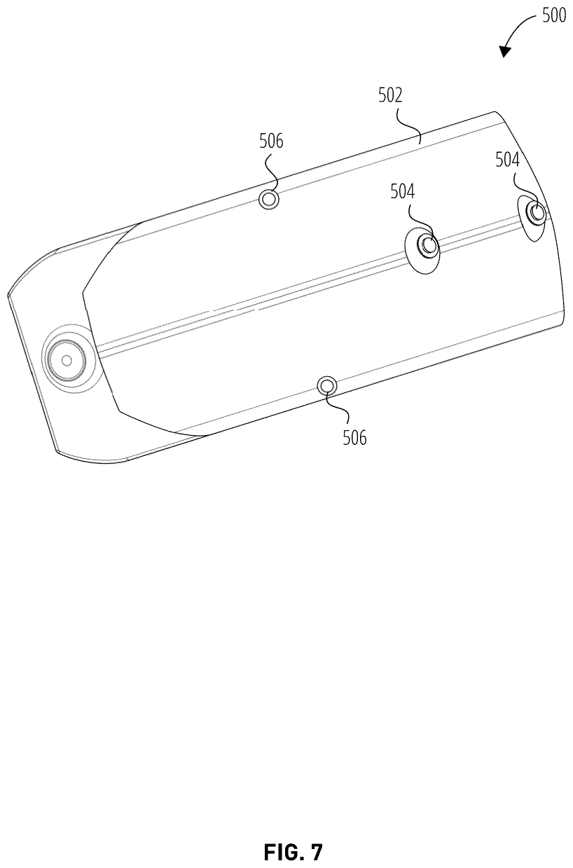

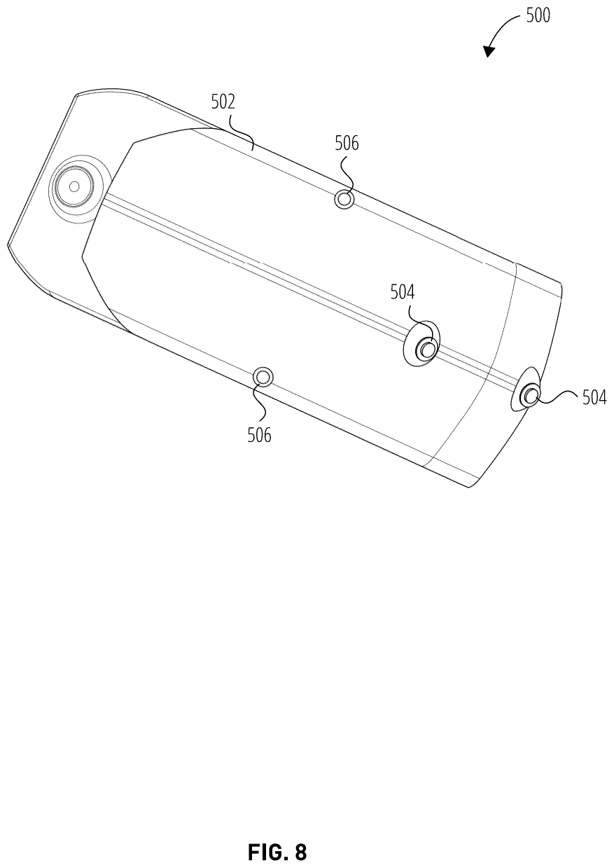

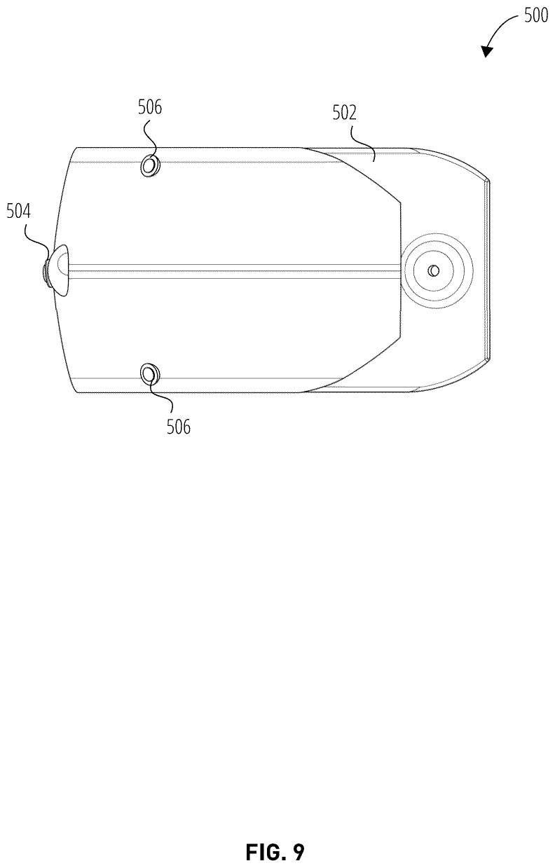

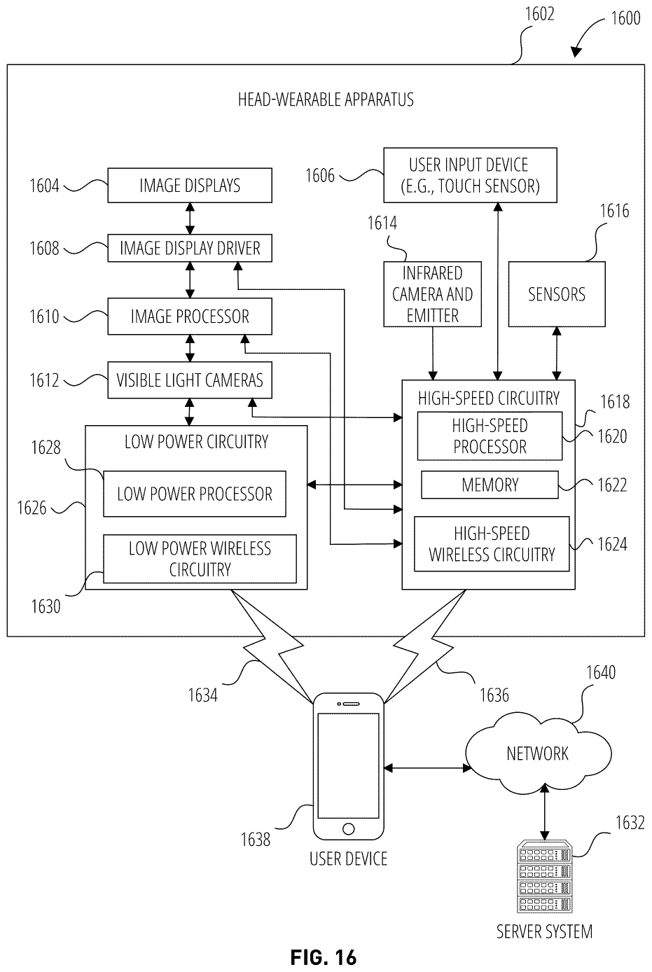

FIGS. 5-10 show various views of a device body 500 of a VST HMD, according to some examples, including image capture components. Specifically, the device body 500 is shown to include an external frame 502 that has two foveal cameras 504 and four peripheral cameras 506 mounted thereto for image capture. It will be appreciated that the VST HMD may include various other components that are not depicted in FIGS. 5-10 (such as components described with reference to FIG. 2 or FIG. 16), and that FIGS. 5-10 are primarily intended to illustrate an example image capture configuration.

The external frame 502 is designed with a curved, wraparound form factor that allows placement of both the foveal cameras 504 and peripheral cameras 506 to capture the user's field of view. The foveal cameras 504 are centrally positioned and aligned with the user's eyes, while the peripheral cameras 506 are placed at the corners and edges of the external frame 502 to provide wide-angle coverage of the surrounding environment. This arrangement integrates a high-resolution foveal view with lower-resolution peripheral views while maintaining a balanced and ergonomic design.

The foveal cameras 504 are positioned to be approximately at eye level during operation (e.g., while a user is wearing the VST HMD) to capture high-resolution images in the user's viewing direction. The peripheral cameras 506 are spaced apart laterally around the external frame 502 relative to the foveal camera 504 to capture wider-angle views at lower resolution.

As a non-limiting example, each foveal camera 504 can be configured for capturing at 1088×1088 pixels over a 12-degree field of view, achieving approximately 90 pdd angular resolution. Further, and for example, each peripheral camera 506 operates at 1456×1088 pixels, covering a 100-degree by 70-degree field of view. When operating at 90 Hz, this configuration requires approximately 28 Gbps of bandwidth, compared to approximately 192 Gbps that would be needed for uniform high-resolution capture across the entire field of view in other implementations.

This bandwidth requirement is within the capabilities of common high-speed interfaces, such as Thunderbolt 4 (e.g., 36 Gbps), and allows the use of commercially available image sensors. An example of such an image sensor is the Sony™ IMX273. The Sony IMX273 is a 1/2.9-type (6.3 mm diagonal) CMOS image sensor featuring approximately 1.58 million effective pixels, each measuring 3.45 μm×3.45 μm. It supports high-speed imaging and can achieve up to 226.5 frames per second in 10-bit mode.

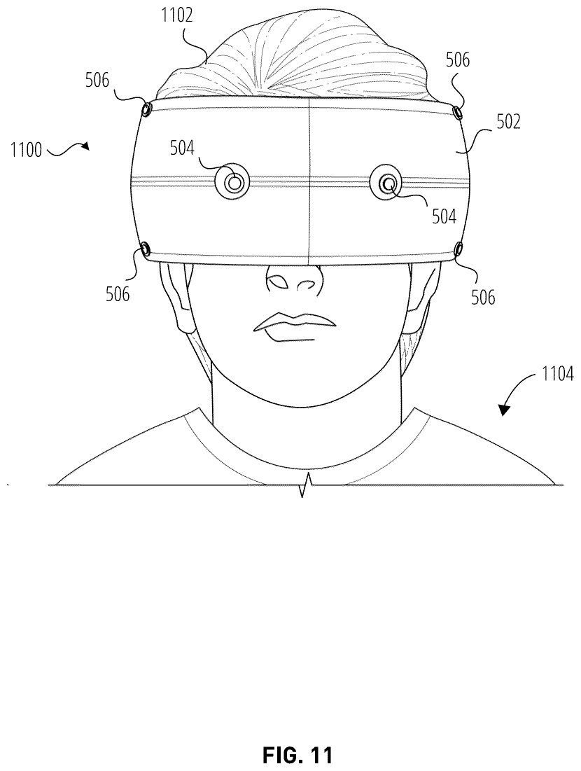

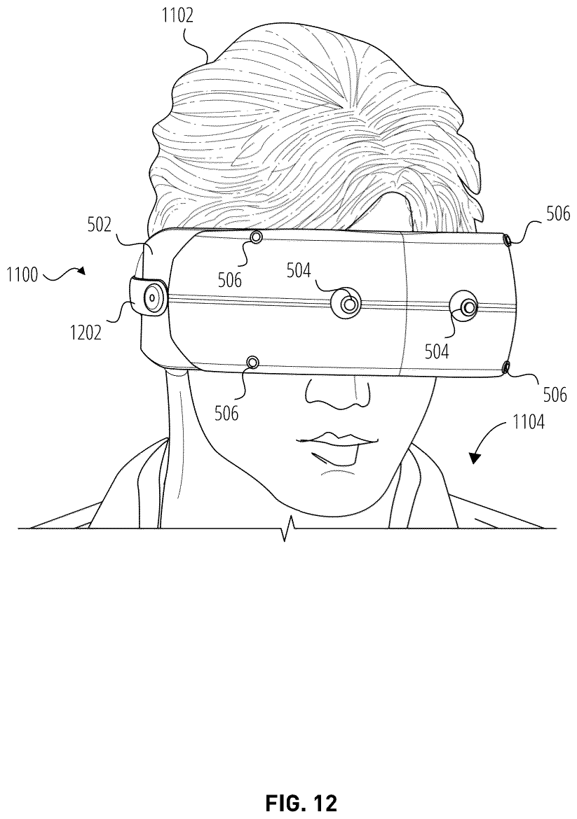

FIGS. 11 and 12 illustrate an HMD 1100 mounted to a head 1102 of a user 1104, showing how the external frame 502 of FIGS. 5-10 is positioned relative to the head 1102. FIG. 12 additionally shows a head strap 1202 that helps secure the HMD 1100 to the head 1102. Other components of the HMD 1100 may be similar to one or more of the components of the XR device 110 as described with reference to FIG. 2.

During operation, the foveal cameras 504 are aligned with the eyes to capture high-resolution images in their viewing direction, while the peripheral cameras 506 capture the surrounding environment. The foveal cameras 504 dynamically adjust based on the user's gaze direction (e.g., through mechanical movement of image sensors or adjustment of light paths to capture in the viewing direction), while the peripheral cameras 506 provide constant wide-angle environmental context, providing high-quality see-through vision that substantially matches or mimics natural human visual characteristics.

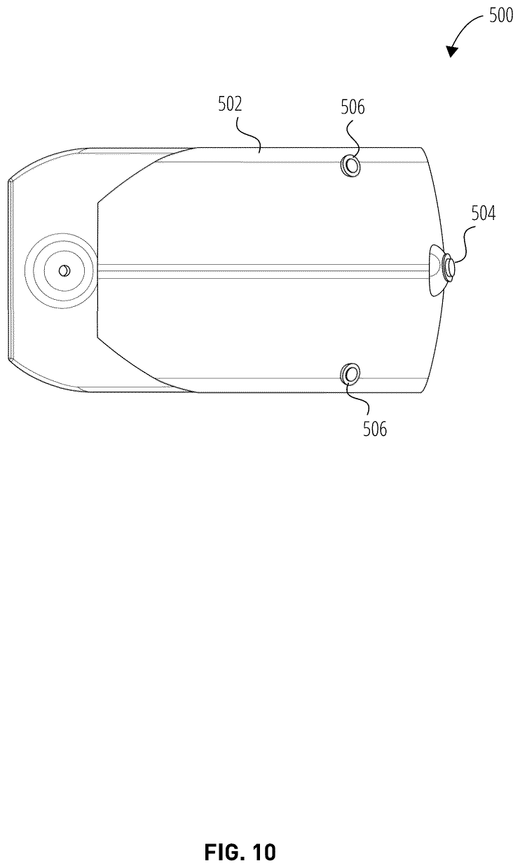

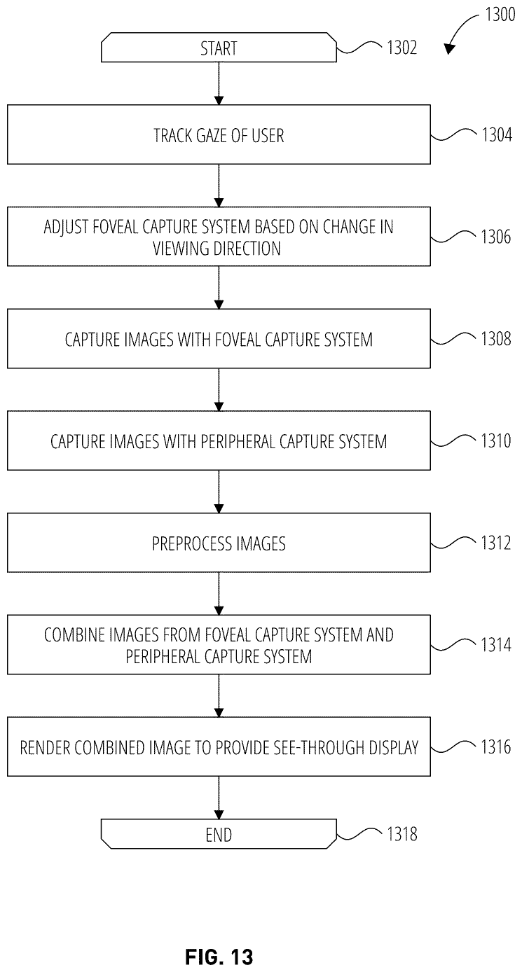

FIG. 13 is a flowchart illustrating a method 1300 for capture and display by an XR device, according to some examples. The method 1300 may be performed by an XR device such as the XR device 110 of FIG. 1 and FIG. 2 or the HMD 1100 of FIG. 10 and FIG. 11. The HMD 1100 is used as a non-limiting example to describe the operations of the method 1300 below.

Although some examples, such as those depicted in the drawings, are provided in a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The method 1300 commences at opening loop element 1302. For example, the user 1104 wears the HMD 1100 and commences a new user session. At operation 1304, an eye tracking system of the HMD 1100 tracks the gaze direction of the user 1104 (e.g., using infrared tracking). The gaze direction can be continuously tracked throughout the user session. The eye tracking data is processed in real-time to detect various movements as the user's gaze changes.

At operation 1306, a foveal capture system (e.g., the foveal cameras 504) automatically adjusts, substantially in real-time, based on gaze changes. This adjustment can be performed through mechanical or optical means. For example, in a mechanical implementation, the eye tracking system of the HMD 1100 tracks the user gaze and provides 3D gaze data, such as a point or points in 3D space relative to a coordinate system of the HMD 1100. The gaze data is filtered (e.g., using an IIR (Infinite Impulse Response) filter with exponential falloff) and the foveal capture system dynamically adjusts through mechanical rotation of one or more cameras such that it is directed at the relevant point or points in 3D space as returned via the filter.

At operation 1308, the foveal capture system captures high-resolution images in the viewing direction with a narrow field of view. For example, the foveal capture system captures 80, 90, or 100 ppd images in a field of view of 12 degrees. Simultaneously, the peripheral capture system (e.g., the peripheral cameras 506) captures additional images with a wider field of view at lower resolution (operation 1310).

At operation 1312, the HMD 1100 preprocesses the captured images. This may include applying color correction, distortion correction, noise reduction, adjusting opacity levels, and preparing images for blending and stitching. The preprocessing may occur at different frame rates for foveal and peripheral captures. For example, peripheral cameras capture at higher speeds for tracking while foveal cameras operate at medium speed for detail capture. Preprocessing can also include stitching or combining views from the peripheral capture system to generate one peripheral view (e.g., from the peripheral cameras 506), or stitching or combining views from the foveal capture system to generate one foveal view (e.g., from the foveal cameras 504).

The method 1300 proceeds to operation 1314, where the HMD 1100 combines the foveal and peripheral images. For example, this includes warping peripheral views, applying stitching functions, and applying blending functions in transition regions between the regions. The HMD 1100 may perform additional processing such as color correction during operation 1314.

At operation 1316, the HMD 1100 renders the combined image to the display (e.g., the display 238 of FIG. 2) to provide video see-through functionality. The rendering maintains high resolution in the foveal region while efficiently managing bandwidth requirements across the full field of view. The high-resolution foveal region appears where the user is looking, surrounded by lower-resolution peripheral content that matches natural visual acuity falloff.

Operations of the method 1300 may execute continuously during device operation to maintain aligned foveal capture with the user's gaze while providing peripheral context. The method 1300 concludes at closing loop element 1318.

In some examples, a VST HMD thus combines image streams from foveal and peripheral capture systems to generate a complete view for a user. The peripheral capture system's images are used primarily to fill in the wider field of view surrounding the high-resolution foveal region. While this combined approach may introduce some warping artifacts in the peripheral regions similar to traditional peripheral-only systems, these artifacts are less noticeable since they occur outside the user's primary viewing direction where visual acuity is naturally lower. Moreover, a blending function is applied between the foveal and peripheral regions to create seamless transitions between the different resolution zones. This selective use of high and low resolution capture, aligned with the human visual system's natural characteristics, helps maintain high visual quality where it matters most from a practical perspective, while efficiently managing bandwidth and processing requirements.

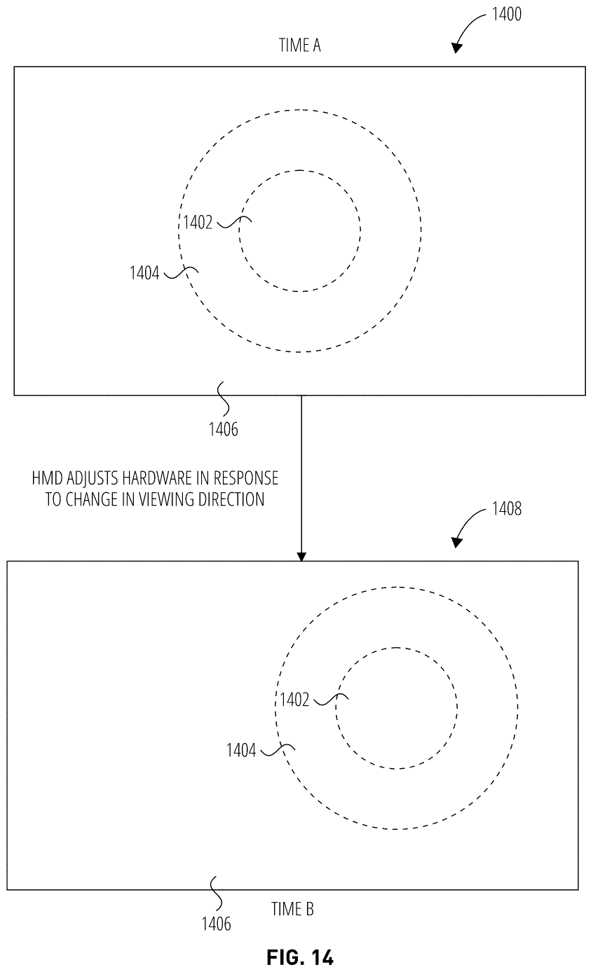

FIG. 14 is a diagrammatic representation showing adjustment of foveal and peripheral regions in response to changes in viewing direction, according to some examples. FIG. 14 shows a rendered view 1400, at Time A, with a foveal region 1402, a transition region 1404, and a peripheral region 1406. The foveal region 1402 provides high-resolution capture aligned with the user's initial viewing direction, surrounded by the transition region 1404 that blends into the peripheral region 1406.

As the user's viewing direction changes, the XR device (e.g., HMD) dynamically adjusts its hardware, which may involve physically moving cameras or manipulating optical paths using steerable mirrors. This adjustment realigns a foveal capture system with the new viewing direction, maintaining high-resolution capture where the user is looking, as shown in a subsequent rendered view 1408 at Time B. At Time B, the foveal region 1402 and the transition region 1404 have shifted to match the new viewing direction.

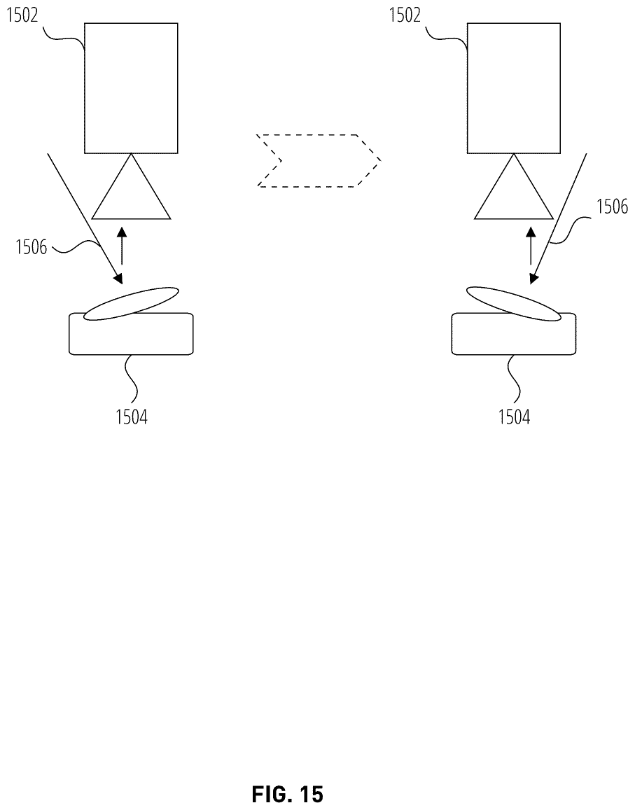

FIG. 15 illustrates a steerable mirror arrangement 1504 for a VST HMD, according to some examples. As discussed elsewhere in the present disclosure, for mechanical adjustment, steering mechanisms physically move the cameras or image sensors. For optical adjustment, steerable mirrors can rapidly redirect the optical path instead of moving the cameras or image sensors themselves.

As shown in FIG. 15, the steerable mirror arrangement 1504 is positioned in front of a camera 1502 to redirect an optical path 1506 of incoming light. As the user's viewing direction changes, the steerable mirror arrangement 1504 can be rapidly adjusted to ensure the foveal cameras maintain alignment with the user's gaze direction, as depicted in FIG. 15 where adjustment of the steerable mirror arrangement 1504 is shown.

An example of a steerable mirror is the Optotune MR-15-30. The Optotune MR-15-30 is a dual-axis fast steering mirror (FSM) designed for applications requiring deflections within a compact form factor. It has a 15 mm diameter mirror, achieving up to approximately 25 degrees in mechanical tilt, resulting in an optical deflection of up to about 50 degrees. The device incorporates a position feedback system for precise control. Accordingly, the device can be used together with an eye tracking system to ensure that the camera 1502 receives light corresponding to the current viewing direction.

FIG. 16 illustrates a network environment 1600 in which a head-wearable apparatus 1602, such as a head-wearable XR device, can be implemented according to some examples. In some examples, the head-wearable apparatus 1602 is in the form of a VST HMD.

FIG. 16 provides a high-level functional block diagram of an example head-wearable apparatus 1602 communicatively coupled to a user device 1638 and a server system 1632 via a suitable network 1640. One or more of the techniques described herein may be performed using the head-wearable apparatus 1602 or a network of devices similar to those shown in FIG. 16.

The head-wearable apparatus 1602 includes cameras, such as visible light cameras 1612 and an infrared camera and emitter 1614. The head-wearable apparatus 1602 includes other sensors 1616, such as motion sensors or eye tracking sensors. The user device 1638 can be capable of connecting with head-wearable apparatus 1602 using both a communication link 1634 and a communication link 1636. The user device 1638 is connected to the server system 1632 via the network 1640. The network 1640 may include any combination of wired and wireless connections.

The head-wearable apparatus 1602 includes a display arrangement that has several components. For example, the arrangement includes two image displays 1604 of an optical assembly. The two displays may include one associated with the left lateral side and one associated with the right lateral side of the head-wearable apparatus 1602. The head-wearable apparatus 1602 also includes an image display driver 1608, an image processor 1610, low power circuitry 1626, and high-speed circuitry 1618. The image displays 1604 are for presenting images and videos, including an image that can provide a graphical user interface to a user of the head-wearable apparatus 1602.

The image display driver 1608 commands and controls the image display of each of the image displays 1604. The image display driver 1608 may deliver image data directly to each image display of the image displays 1604 for presentation or may have to convert the image data into a signal or data format suitable for delivery to each image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (Exif) or the like.

The images and videos may be presented to a user by directed light from the image displays 1604 along respective optical paths to the eyes of the user. The head-wearable apparatus 1602 may include a frame and stems (or temples) extending from a lateral side of the frame, or another component (e.g., a head strap) to facilitate wearing of the head-wearable apparatus 1602 by a user. The head-wearable apparatus 1602 of FIG. 16 further includes a user input device 1606 (e.g., touch sensor or push button) including an input surface on the head-wearable apparatus 1602. The user input device 1606 is configured to receive, from the user, an input selection to manipulate the graphical user interface of the presented image.

At least some components shown in FIG. 16 for the head-wearable apparatus 1602 are located on one or more circuit boards, for example a printed circuit board (PCB) or flexible PCB, in the head-wearable apparatus 1602. Depicted components can be located in frames, chunks, hinges, or bridges of the head-wearable apparatus 1602, for example. Left and right sides of the head-wearable apparatus 1602 may each include a digital camera element such as a complementary metal-oxide-semiconductor (CMOS) image sensor, charge coupled device, a camera lens, or any other respective visible or light capturing elements that may be used to capture data, including images of scenes with unknown objects.

The head-wearable apparatus 1602 includes a memory 1622 which stores instructions to perform a subset or all of the functions described herein. The memory 1622 can also include a storage device. As further shown in FIG. 16, the high-speed circuitry 1618 includes a high-speed processor 1620, the memory 1622, and high-speed wireless circuitry 1624. In FIG. 16, the image display driver 1608 is coupled to the high-speed circuitry 1618 and operated by the high-speed processor 1620 in order to drive the left and right image displays of the image displays 1604. The high-speed processor 1620 may be any processor capable of managing high-speed communications and operation of any general computing system needed for the head-wearable apparatus 1602. The high-speed processor 1620 includes processing resources needed for managing high-speed data transfers over the communication link 1636 to a wireless local area network (WLAN) using high-speed wireless circuitry 1624. In certain examples, the high-speed processor 1620 executes an operating system such as a LINUX operating system or other such operating system of the head-wearable apparatus 1602 and the operating system is stored in memory 1622 for execution. In addition to any other responsibilities, the high-speed processor 1620 executing a software architecture for the head-wearable apparatus 1602 is used to manage data transfers with high-speed wireless circuitry 1624. In certain examples, high-speed wireless circuitry 1624 is configured to implement Institute of Electrical and Electronic Engineers (IEEE) 1602.11 communication standards, also referred to herein as Wi-Fi™. In other examples, other high-speed communications standards may be implemented by high-speed wireless circuitry 1624.

The low power wireless circuitry 1630 and the high-speed wireless circuitry 1624 of the head-wearable apparatus 1602 can include short range transceivers (Bluetooth™) and wireless wide, local, or wide area network transceivers (e.g., cellular or Wi-Fi™). The user device 1638, including the transceivers communicating via the communication link 1634 and communication link 1636, may be implemented using details of the architecture of the head-wearable apparatus 1602, as can other elements of the network 1640.

The memory 1622 may include any storage device capable of storing various data and applications, including, among other things, camera data generated by the visible light cameras 1612, sensors 1616, and the image processor 1610, as well as images generated for display by the image display driver 1608 on the image displays of the image displays 1604. While the memory 1622 is shown as integrated with the high-speed circuitry 1618, in other examples, the memory 1622 may be an independent standalone element of the head-wearable apparatus 1602. In certain such examples, electrical routing lines may provide a connection through a chip that includes the high-speed processor 1620 from the image processor 1610 or low power processor 1628 to the memory 1622. In other examples, the high-speed processor 1620 may manage addressing of memory 1622 such that the low power processor 1628 will boot the high-speed processor 1620 any time that a read or write operation involving memory 1622 is needed.

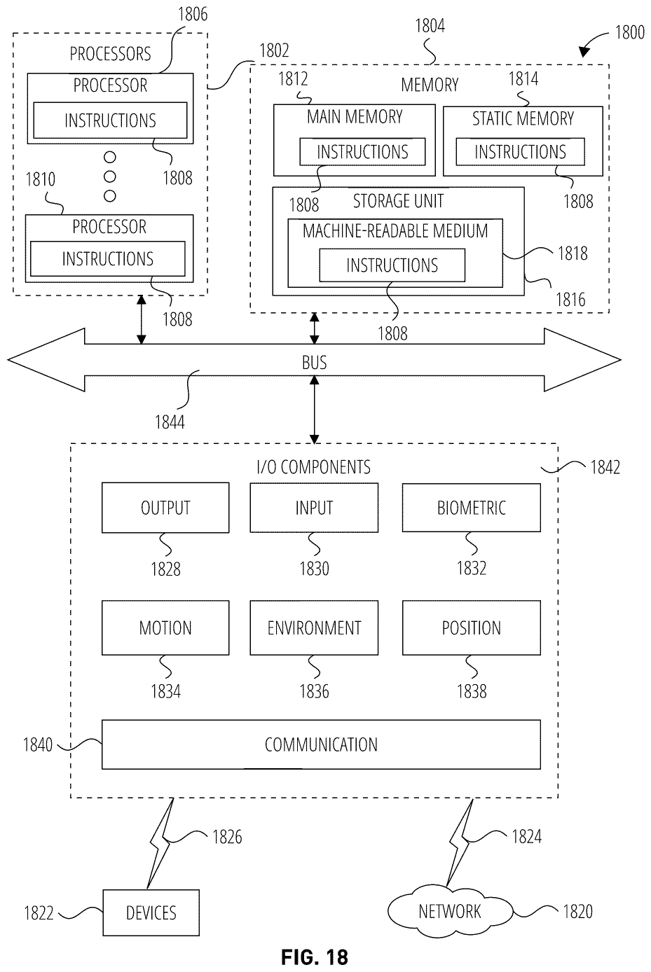

As shown in FIG. 16, the low power processor 1628 or high-speed processor 1620 of the head-wearable apparatus 1602 can be coupled to the camera (visible light cameras 1612, or infrared camera and emitter 1614), the image display driver 1608, the user input device 1606 (e.g., touch sensor or push button), and the memory 1622. The head-wearable apparatus 1602 also includes sensors 1616, which may be the motion components 1834, position components 1838, environmental components 1836, and biometric components 1832, e.g., as described below with reference to FIG. 18. In particular, motion components 1834 and position components 1838 are used by the head-wearable apparatus 1602 to determine and keep track of the position and orientation (the “pose”) of the head-wearable apparatus 1602 relative to a frame of reference or another object, in conjunction with a video feed from one of the visible light cameras 1612, using for example techniques such as structure from motion (SfM) or VIO.

In some examples, and as shown in FIG. 16, the head-wearable apparatus 1602 is connected with a host computer. For example, the head-wearable apparatus 1602 is paired with the user device 1638 via the communication link 1636 or connected to the server system 1632 via the network 1640. The server system 1632 may be one or more computing devices as part of a service or network computing system, for example, that include a processor, a memory, and network communication interface to communicate over the network 1640 with the user device 1638 and head-wearable apparatus 1602.

The user device 1638 includes a processor and a network communication interface coupled to the processor. The network communication interface allows for communication over the network 1640, communication link 1634 or communication link 1636. The user device 1638 can further store at least portions of the instructions for implementing functionality described herein.

Output components of the head-wearable apparatus 1602 include visual components, such as a display (e.g., one or more liquid-crystal display (LCD)), one or more plasma display panel (PDP), one or more light emitting diode (LED) display, one or more projector, or one or more waveguide. The image displays 1604 described above are examples of such a display. In some examples, the image displays 1604 are driven by the image display driver 1608.

The output components of the head-wearable apparatus 1602 may further include acoustic components (e.g., speakers), haptic components (e.g., a vibratory motor), other signal generators, and so forth. The input components of the head-wearable apparatus 1602, the user device 1638, and server system 1632, such as the user input device 1606, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 1602 may optionally include additional peripheral device elements. Such peripheral device elements may include biometric sensors, additional sensors, or display elements integrated with the head-wearable apparatus 1602. For example, peripheral device elements may include any I/O components including output components, motion components, position components, or any other such elements described herein.

For example, the biometric components include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi™ or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over a communication link 1636 from the user device 1638 via the low power wireless circuitry 1630 or high-speed wireless circuitry 1624.

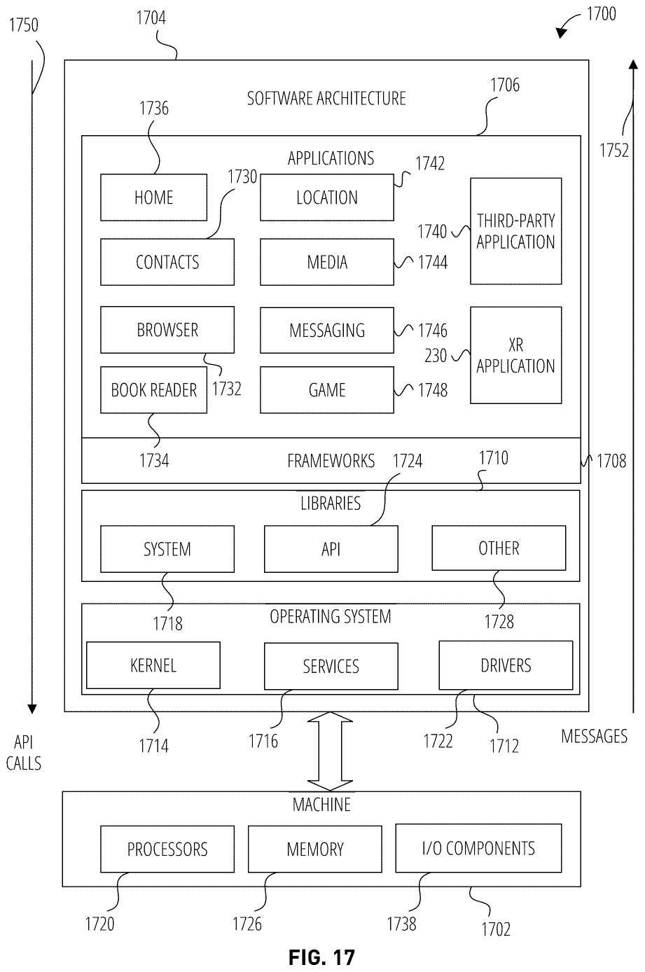

FIG. 17 is a block diagram 1700 illustrating a software architecture 1704, which can be installed on one or more of the devices described herein, according to some examples. The software architecture 1704 is supported by hardware such as a machine 1702 that includes processors 1720, memory 1726, and I/O components 1738. In this example, the software architecture 1704 can be conceptualized as a stack of layers, where each layer provides a particular functionality. The software architecture 1704 includes layers such as an operating system 1712, libraries 1710, frameworks 1708, and applications 1706. Operationally, the applications 1706 invoke API calls 1750, through the software stack and receive messages 1752 in response to the API calls 1750.

The operating system 1712 manages hardware resources and provides common services. The operating system 1712 includes, for example, a kernel 1714, services 1716, and drivers 1722. The kernel 1714 acts as an abstraction layer between the hardware and the other software layers. For example, the kernel 1714 provides memory management, processor management (e.g., scheduling), component management, networking, and security settings, among other functionality. The services 1716 can provide other common services for the other software layers. The drivers 1722 are responsible for controlling or interfacing with the underlying hardware. For instance, the drivers 1722 can include display drivers, camera drivers, Bluetooth™ or Bluetooth™ Low Energy drivers, flash memory drivers, serial communication drivers (e.g., Universal Serial Bus (USB) drivers), Wi-Fi™ drivers, audio drivers, power management drivers, and so forth.

The libraries 1710 provide a low-level common infrastructure used by the applications 1706. The libraries 1710 can include system libraries 1718 (e.g., C standard library) that provide functions such as memory allocation functions, string manipulation functions, mathematic functions, and the like. In addition, the libraries 1710 can include API libraries 1724 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and 3D in a graphic content on a display), database libraries (e.g., SQLite to provide various relational database functions), web libraries (e.g., WebKit to provide web browsing functionality), and the like. The libraries 1710 can also include a wide variety of other libraries 1728 to provide many other APIs to the applications 1706.

The frameworks 1708 provide a high-level common infrastructure that is used by the applications 1706. For example, the frameworks 1708 provide various graphical user interface (GUI) functions, high-level resource management, and high-level location services. The frameworks 1708 can provide a broad spectrum of other APIs that can be used by the applications 1706, some of which may be specific to a particular operating system or platform.

In some examples, the applications 1706 may include a home application 1736, a contacts application 1730, a browser application 1732, a book reader application 1734, a location application 1742, a media application 1744, a messaging application 1746, a game application 1748, and a broad assortment of other applications such as a third-party application 1740. In some examples, the applications 1706 are programs that execute functions defined in the programs. Various programming languages can be employed to create one or more of the applications 1706, structured in a variety of manners, such as object-oriented programming languages (e.g., Objective-C, Java, or C++) or procedural programming languages (e.g., C or assembly language). In some examples, the third-party application 1740 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In FIG. 17, the third-party application 1740 can invoke the API calls 1750 provided by the operating system 1712 to facilitate functionality described herein. The applications 1706 may include an XR application such as the XR application 230 described herein, according to some examples.

FIG. 18 is a diagrammatic representation of a machine 1800 within which instructions 1808 (e.g., software, a program, an application, an applet, an app, or other executable code) for causing the machine 1800 to perform any one or more of the methodologies discussed herein may be executed, according to some examples. For example, the instructions 1808 may cause the machine 1800 to execute any one or more of the methods described herein. The instructions 1808 transform the general, non-programmed machine 1800 into a particular machine 1800 programmed to carry out the described and illustrated functions in the manner described. The machine 1800 may operate as a standalone device or may be coupled (e.g., networked) to other machines.

In a networked deployment, the machine 1800 may operate in the capacity of a server machine or a client machine in a server-client network environment, or as a peer machine in a peer-to-peer (or distributed) network environment. The machine 1800 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), XR device, a smart home device (e.g., a smart appliance), other smart devices, a web appliance, a network router, a network switch, a network bridge, or any machine capable of executing the instructions 1808, sequentially or otherwise, that specify actions to be taken by the machine 1800. Further, while only a single machine 1800 is illustrated, the term “machine” shall also be taken to include a collection of machines that individually or jointly execute the instructions 1808 to perform any one or more of the methodologies discussed herein.

The machine 1800 may include processors 1802, memory 1804, and I/O components 1842, which may be configured to communicate with each other via a bus 1844. In some examples, the processors 1802 may include, for example, a processor 1806 and a processor 1810 that execute the instructions 1808. Although FIG. 18 shows multiple processors 1802, the machine 1800 may include a single processor with a single core, a single processor with multiple cores (e.g., a multi-core processor), multiple processors with a single core, multiple processors with multiples cores, or any combination thereof.

The memory 1804 includes a main memory 1812, a static memory 1814, and a storage unit 1816, accessible to the processors via the bus 1844. The main memory 1804, the static memory 1814, and storage unit 1816 store the instructions 1808 embodying any one or more of the methodologies or functions described herein. The instructions 1808 may also reside, completely or partially, within the main memory 1812, within the static memory 1814, within machine-readable medium 1818 within the storage unit 1816, within at least one of the processors, or any suitable combination thereof, during execution thereof by the machine 1800.

The I/O components 1842 may include a wide variety of components to receive input, provide output, produce output, transmit information, exchange information, capture measurements, and so on. The specific I/O components 1842 that are included in a particular machine will depend on the type of machine. For example, portable machines such as mobile phones may include a touch input device or other such input mechanisms, while a headless server machine will likely not include such a touch input device. It will be appreciated that the I/O components 1842 may include many other components that are not shown in FIG. 18. In various examples, the I/O components 1842 may include output components 1828 and input components 1830. The output components 1828 may include visual components (e.g., a display such as a plasma display panel (PDP), a light emitting diode (LED) display, a LCD, a projector, or a cathode ray tube (CRT)), acoustic components (e.g., speakers), haptic components (e.g., a vibratory motor, resistance mechanisms), other signal generators, and so forth. The input components 1830 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In some examples, the I/O components 1842 may include biometric components 1832, motion components 1834, environmental components 1836, or position components 1838, among a wide array of other components. For example, the biometric components 1832 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1834 include acceleration sensor components (e.g., accelerometer), gravitation sensor components, rotation sensor components (e.g., gyroscope), and so forth. The environmental components 1836 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1838 include location sensor components (e.g., a GPS receiver components), altitude sensor components (e.g., altimeters or barometers that detect air pressure from which altitude may be derived), orientation sensor components (e.g., magnetometers), and the like.

Any biometric data collected by the biometric components is captured and stored with only user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

Communication may be implemented using a wide variety of technologies. The I/O components 1842 further include communication components 1840 operable to couple the machine 1800 to a network 1820 or devices 1822 via a coupling 1824 and a coupling 1826, respectively. For example, the communication components 1840 may include a network interface component or another suitable device to interface with the network 1820. In further examples, the communication components 1840 may include wired communication components, wireless communication components, cellular communication components, Near Field Communication (NFC) components, Bluetooth™ components, Wi-Fi™ components, and other communication components to provide communication via other modalities. The devices 1822 may be another machine or any of a wide variety of peripheral devices (e.g., a peripheral device coupled via a USB).

Moreover, the communication components 1840 may detect identifiers or include components operable to detect identifiers. For example, the communication components 1840 may include Radio Frequency Identification (RFID) tag reader components, NFC smart tag detection components, optical reader components (e.g., an image sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1840, such as location via Internet Protocol (IP) geolocation, location via Wi-Fi™ signal triangulation, location via detecting an NFC beacon signal that may indicate a particular location, and so forth.

The various memories (e.g., memory 1804, main memory 1812, static memory 1814, and/or memory of the processors 1802) and/or storage unit 1816 may store one or more sets of instructions and data structures (e.g., software) embodying or used by any one or more of the methodologies or functions described herein. These instructions (e.g., the instructions 1808), when executed by processors 1802, cause various operations to implement the disclosed examples.

The instructions 1808 may be transmitted or received over the network 1820, using a transmission medium, via a network interface device (e.g., a network interface component included in the communication components 1840) and using any one of a number of well-known transfer protocols (e.g., hypertext transfer protocol (HTTP)). Similarly, the instructions 1808 may be transmitted or received using a transmission medium via the coupling 1826 (e.g., a peer-to-peer coupling) to the devices 1822.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks.

The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine 1800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

Although aspects have been described with reference to specific examples, it will be evident that various modifications and changes may be made to these examples without departing from the broader scope of the present disclosure. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

As used herein, the term “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), an FPGA, a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, Very Long Instruction Word (VLIW), vector processing, or Single Instruction, Multiple Data (SIMD) that allow each core to run separate instruction streams concurrently. A processor may be emulated in software, running on a physical processor, as a virtual processor or virtual circuit. The virtual processor may behave like an independent processor but is implemented in software rather than hardware.

Unless the context clearly requires otherwise, in the present disclosure, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

The various features, steps, operations, and processes described herein may be used independently of one another, or may be combined in various ways. All possible combinations and subcombinations are intended to fall within the scope of this disclosure. In addition, certain method or process blocks or operations may be omitted in some implementations.

### EXAMPLES

In view of the above-described implementations of subject matter this application discloses the following list of examples, wherein one feature of an example in isolation, or more than one feature of an example taken in combination, and, optionally, in combination with one or more features of one or more further examples, are further examples also falling within the disclosure of this application.

Example 1 is a VST HMD comprising: at least one display; a foveal capture system to capture images in a direction corresponding to a viewing direction of a user, the foveal capture system covering a field of view of less than 25 degrees at an angular resolution of at least 60 pixels per degree; a peripheral capture system to capture additional images with a wider field of view than the foveal capture system and a lower angular resolution than the foveal capture system; and one or more processors to: dynamically adjust the foveal capture system based on the viewing direction of the user, and render, based on the images and the additional images, processed images for presentation to the user via the at least one display.

In Example 2, the subject matter of Example 1 includes, an eye tracking system to determine the viewing direction of the user, wherein the foveal capture system is dynamically adjusted based at least partially on output from the eye tracking system.

In Example 3, the subject matter of Example 2 includes, wherein the eye tracking system is to detect a change in the viewing direction to trigger dynamic adjustment of the foveal capture system.

In Example 4, the subject matter of any of Examples 1-3 includes, wherein each of the processed images comprises: a foveal region corresponding to the viewing direction and displaying a foveal view obtained from the foveal capture system; and a peripheral region at least partially surrounding the foveal region and displaying a peripheral view obtained from the peripheral capture system.

In Example 5, the subject matter of Example 4 includes, wherein the one or more processors are to generate the processed images by applying a blending function between the foveal region and the peripheral region.

In Example 6, the subject matter of Example 5 includes, wherein the blending function comprises a linear blending function.

In Example 7, the subject matter of Examples 4-6 includes, wherein each of the processed images further comprises: a transition region between the foveal region and the peripheral region, wherein the one or more processors are to blend one or more of the images from the foveal capture system and one or more of the additional images from the peripheral capture system within the transition region.

In Example 8, the subject matter of Example 7 includes, wherein the one or more processors are to apply a blending function in the transition region.

In Example 9, the subject matter of Examples 7-8 includes, wherein the one or more processors are to perform at least one of opacity adjustment or color correction in the transition region.

In Example 10, the subject matter of Examples 1-9 includes, wherein the one or more processors are to: warp views from the peripheral capture system towards one or more views from the foveal capture system; and apply blending between the warped peripheral views and the one or more views from the foveal capture system.

In Example 11, the subject matter of Examples 1-10 includes, wherein the one or more processors are to apply one or more stitching functions to perform at least one of: combining peripheral views from different peripheral image sensors of the peripheral capture system; combining foveal views from different foveal image sensors of the foveal capture system; or combining foveal and peripheral views to combine at least one of the images with at least one of the additional images.

In Example 12, the subject matter of Examples 1-11 includes, wherein dynamically adjusting the foveal capture system comprises at least one of: triggering physical movement of one or more image sensors of the foveal capture system relative to a frame or body of the HMD such that the foveal capture system captures in the viewing direction; or manipulating an optical path of incoming light such that the foveal capture system captures in the viewing direction.

In Example 13, the subject matter of Example 12 includes, wherein the HMD comprises a steering mechanism to move the one or more image sensors.

In Example 14, the subject matter of Examples 12-13 includes, wherein the HMD comprises one or more steerable mirrors to manipulate the optical path.

In Example 15, the subject matter of Examples 12-14 includes, wherein the physical movement is triggered, or the optical path is manipulated based on output from an eye tracking system.

In Example 16, the subject matter of Examples 1-15 includes, wherein: the peripheral capture system comprises at least two peripheral image sensors to capture different portions of a peripheral field of view; and the one or more processors are to combine the different portions to generate a peripheral view to be combined with a foveal view obtained from the foveal capture system.

In Example 17, the subject matter of Examples 1-16 includes, wherein the angular resolution of the foveal capture system is at least 70 pixels per degree.

In Example 18, the subject matter of Examples 1-17 includes, wherein the angular resolution of the foveal capture system is at least 80 pixels per degree.

In Example 19, the subject matter of Examples 1-18 includes, wherein the angular resolution of the foveal capture system is at least 90 pixels per degree.

In Example 20, the subject matter of Examples 1-19 includes, wherein the field of view of the foveal capture system is less than 20 degrees.

In Example 21, the subject matter of Examples 1-20 includes, wherein the field of view of the foveal capture system is less than 15 degrees.

In Example 22, the subject matter of Examples 1-21 includes, wherein the foveal capture system comprises at least two image sensors.

In Example 23, the subject matter of Examples 1-22 includes, wherein the foveal capture system comprises one or more image sensors positioned so as to be approximately at eye level of the user, in use, to capture the images from a perspective corresponding to eyes of the user.

In Example 24, the subject matter of Examples 1-23 includes, wherein the peripheral capture system comprises multiple image sensors spaced apart laterally on a frame or body of the HMD.

In Example 25, the subject matter of Examples 1-24 includes, wherein the peripheral capture system comprises at least two peripheral image sensors configured to capture different portions of a peripheral field of view.

In Example 26, the subject matter of Examples 1-25 includes, wherein the peripheral capture system comprises at least four peripheral image sensors configured to capture different portions of a peripheral field of view.

In Example 27, the subject matter of Examples 1-26 includes, wherein the one or more processors are to perform object tracking using the additional images from the peripheral capture system.

In Example 28, the subject matter of Examples 1-27 includes, wherein the foveal capture system comprises one or more varifocal mechanisms to adjust focus depth of the images.

In Example 29, the subject matter of Example 28 includes, wherein the one or more processors are to determine the focus depth using at least one of: a depth camera, gaze point data, or eye analysis data.

In Example 30, the subject matter of Examples 1-29 includes, wherein the peripheral capture system comprises one or more fixed-focus image sensors, and the foveal capture system comprises one or more varifocal image sensors.

In Example 31, the subject matter of Examples 1-30 includes, wherein the foveal capture system comprises: a single image sensor; and an optical system to create multiple optical paths from different directions to the single image sensor.

In Example 32, the subject matter of Example 31 includes, wherein the optical system comprises: a digital micromirror device (DMD) to rapidly switch the optical paths between the different directions.

In Example 33, the subject matter of Examples 31-32 includes, wherein: the single image sensor operates at a frame rate of at least 200 Hz; and the one or more processors are to temporally multiplex the optical paths.

In Example 34, the subject matter of Examples 1-33 includes, wherein: the peripheral capture system operates at a first frame rate; and the foveal capture system operates at a second frame rate lower than the first frame rate.

In Example 35, the subject matter of Examples 1-34 includes, wherein the at least one display is to display content at an adjustable focus depth.

In Example 36, the subject matter of Example 36 includes, wherein the at least one display forms part of a display arrangement with adjustable elements for adjusting the focus depth during operation.

Example 37 is a VST arrangement for an XR device such as an HMD, the VST arrangement comprising: a foveal capture system to capture images in a direction corresponding to a viewing direction of a user, the foveal capture system covering a field of view of less than 25 degrees at an angular resolution of at least 60 pixels per degree; and a peripheral capture system to capture additional images with a wider field of view and a lower angular resolution than the foveal capture system.

Example 38 is a method performed by a VST HMD, the method comprising: capturing first images in a direction corresponding to a viewing direction of a user, the first images being captured using a first field of view of less than 25 degrees at a first angular resolution of at least 60 pixels per degree; capturing second images using a second field of view and at a second angular resolution, the second field of view being wider than the first field of view, and the second angular resolution being lower than the first angular resolution; dynamically adjusting capturing of the first images based on changes in the viewing direction; and rendering processed images based on the first images and the second images.

Example 39 is at least one machine-readable medium including instructions that, when executed by processing circuitry, cause the processing circuitry to perform operations to implement any of Examples 1-38.

Example 40 is an apparatus comprising means to implement any of Examples 1-38.

Example 41 wherein the apparatus is an XR apparatus.

Example 42 is a system to implement any of Examples 1-38.

Example 43 is a method to implement any of Examples 1-38.

What is claimed is:

1. A video see-through (VST) head-mounted display (HMD) comprising:
at least one display;
a foveal capture system to capture images in a direction corresponding to a viewing direction of a user, the foveal capture system covering a field of view of less than 25 degrees at an angular resolution of at least 60 pixels per degree;
a peripheral capture system to capture additional images with a wider field of view than the foveal capture system and a lower angular resolution than the foveal capture system; and
one or more processors to:
dynamically adjust the foveal capture system based on the viewing direction of the user, and
render, based on the images and the additional images, processed images for presentation to the user via the at least one display.

2. The VST HMD of claim 1, wherein the angular resolution of the foveal capture system is at least 70 pixels per degree.

3. The VST HMD of claim 2, wherein the angular resolution of the foveal capture system is at least 80 pixels per degree.

4. The VST HMD of claim 1, wherein the field of view of the foveal capture system is less than 20 degrees.

5. The VST HMD of claim 1, further comprising:
an eye tracking system to determine the viewing direction of the user,
wherein the foveal capture system is dynamically adjustable based at least partially on output from the eye tracking system indicating a change in the viewing direction.

6. The VST HMD of claim 1, wherein each of the processed images comprises:
a foveal region corresponding to the viewing direction and displaying a foveal view obtained from the foveal capture system; and
a peripheral region at least partially surrounding the foveal region and displaying a peripheral view obtained from the peripheral capture system.

7. The VST HMD of claim 6, wherein the one or more processors are to generate the processed images by applying a blending function between the foveal region and the peripheral region.

8. The VST HMD of claim 7, wherein the blending function is applied in a transition region between the foveal region and the peripheral region.

9. The VST HMD of claim 1, wherein the one or more processors are to apply one or more stitching functions to perform at least one of:
combining peripheral views from different peripheral image sensors of the peripheral capture system;
combining foveal views from different foveal image sensors of the foveal capture system; or
combining foveal and peripheral views to combine at least one of the images with at least one of the additional images.

10. The VST HMD of claim 1, wherein dynamically adjusting the foveal capture system comprises triggering physical movement of one or more image sensors of the foveal capture system relative to a frame or body of the VST HMD such that the foveal capture system captures in the viewing direction.

11. The VST HMD of claim 1, wherein dynamically adjusting the foveal capture system comprises manipulating an optical path of incoming light such that the foveal capture system captures in the viewing direction.

12. The VST HMD of claim 1, wherein:
the peripheral capture system comprises at least two peripheral image sensors to capture different portions of a peripheral field of view; and
the one or more processors are to combine the different portions to generate a peripheral view to be combined with a foveal view obtained from the foveal capture system.

13. The VST HMD of claim 1, wherein the foveal capture system comprises at least two image sensors.

14. The VST HMD of claim 1, wherein the foveal capture system comprises one or more image sensors positioned so as to be approximately at eye level of the user, in use, to capture the images from a perspective corresponding to eyes of the user.

15. The VST HMD of claim 1, wherein the peripheral capture system comprises at least two peripheral image sensors configured to capture different portions of a peripheral field of view.

16. The VST HMD of claim 1, wherein the peripheral capture system comprises at least four peripheral image sensors configured to capture different portions of a peripheral field of view.

17. The VST HMD of claim 1, wherein:
the peripheral capture system operates at a first frame rate; and
the foveal capture system operates at a second frame rate lower than the first frame rate.

18. A video see-through (VST) arrangement for an extended reality (XR) device, the VST arrangement comprising:
a foveal capture system to capture images in a direction corresponding to a viewing direction of a user, the foveal capture system covering a field of view of less than 25 degrees at an angular resolution of at least 60 pixels per degree; and
a peripheral capture system to capture additional images with a wider field of view and a lower angular resolution than the foveal capture system.

19. A method performed by a video see-through (VST) head-mounted display (HMD), the method comprising:
capturing first images in a direction corresponding to a viewing direction of a user, the first images being captured using a first field of view of less than 25 degrees at a first angular resolution of at least 60 pixels per degree;
capturing second images using a second field of view and at a second angular resolution, the second field of view being wider than the first field of view, and the second angular resolution being lower than the first angular resolution;
dynamically adjusting capturing of the first images based on changes in the viewing direction; and
rendering processed images based on the first images and the second images.

20. The method of claim 19, further comprising:
tracking, by an eye tracking system of the VST HMD, the viewing direction of the user.
